(19) United States
(12) Patent Application Publication
(10) Pub. No.: US 2013/0260298 A1
(43) Pub. Date: Oct. 3, 2013

(54) TONER, DEVELOPER AND IMAGE FORMING APPARATUS

(71) Applicants: Suzuka AMEMORI, Shizuoka (JP); Masahide YAMADA, Shizuoka (JP); Shinya NAKAYAMA, Shizuoka (JP); Yukiko NAKAJIMA, Kanagawa (JP)

(72) Inventors: Suzuka AMEMORI, Shizuoka (JP); Masahide YAMADA, Shizuoka (JP); Shinya NAKAYAMA, Shizuoka (JP); Yukiko NAKAJIMA, Kanagawa (JP)

(21) Appl. No.: 13/790,525

(22) Filed: Mar. 8, 2013

(30) Foreign Application Priority Data
Mar. 28, 2012 (JP) 2012-074013

(51) Int. Cl. G03G 9/00; G03G 15/08

(52) U.S. Cl. CPC G03G 9/08755
USPC 430/105; 399/252; 430/109.1; 430/109.4

(57) ABSTRACT

A toner including: a binder resin; and a colorant, wherein the toner is obtained by dispersing or emulsifying an oil phase in an aqueous solvent containing an organic sulfonic acid salt and an inorganic salt, the oil phase including the binder resin and the colorant dissolved or dispersed in an organic solvent, wherein the binder resin comprises a crystalline resin in an amount of 50% by mass or more relative to the binder resin, and wherein the toner has an average circularity of 0.980 or less.

### BACKGROUND OF THE INVENTION

1. Field of the Invention

The present invention relates to a toner, a developer and an image forming apparatus.

2. Description of the Related Art

Conventionally, in image forming apparatus, a latent image electrically or magnetically formed is developed with a toner. For example, in electrophotography, the latent image is formed on a photoconductor and developed with the toner to form a toner image. The toner image is transferred onto a recording medium such as paper and fixed on the transfer target. In a fixing step of fixing the toner image on the recording medium, heat-fixing methods are widely used because of their high energy efficiency, including a heat roller fixing method and a heat belt fixing method.

In recent years, as the aforementioned image forming apparatus has become popular, the toner has been required to have high resolution, high gradation, cleanability and environmental stability. In order for the toner to have the environmental stability, the toner has to have low-temperature fixing property. Thus, there has been proposed a method of increasing the amount of a crystalline resin in a binder resin to decrease the softening temperature of the binder resin contained in the toner. However, when the softening temperature of the binder resin is low, part of the toner image is attached to the surface of a fixing member during fixing of the image and then transferred onto the recording medium, which is problematic. In addition, the toner is degraded in heat resistance, so that particles of the toner are bound to each other under a high-temperature environment, which is also problematic.

In view of this, in order to improve the heat resistance and the low-temperature fixing property at the same time, one proposed toner is defined in terms of a peak temperature for the heat of fusion of a crystalline resin and of a ratio between a softening temperature of a crystalline resin and a peak temperature for the heat of fusion thereof (see Japanese Patent Application Laid-Open (JP-A) No. 2010-77419).

However, when the above toner is used as a one-component developer and passes through a gap between a toner bearing member (e.g., a developing roller) and a regulating member while being rubbed, the crystalline resin adheres to the regulating member, leading to poor cleanability. Also, in a toner containing the crystalline resin, when the resin is dissolved under heating during emulsification, oil droplets are increased in surface energy. As a result, the oil droplets become spherical so that their surface area becomes minimal, leading to poor cleanability.

In view of this, in order to improve the cleanability, there have been proposed a toner containing a crystalline resin the surface of which is provided with protrusions made of vinyl resin particles, and a toner containing a crystalline resin the entire surface of which is coated with a shell layer containing an amorphous polymer to reduce the average circularity of the toner (see JP-A Nos. 2011-123483 and 2005-215298).

However, a resin used for a core layer on which protrusions are to be provided is high in viscosity when dissolved, so that the low-temperature fixing property may be insufficient. When the shell layer is coated on the entire surface of the crystalline resin, the effects of the crystalline resin cannot be obtained sufficiently. A problem occurs that the low-temperature fixing property is not sufficiently exhibited.

That is, these toners possess a problem of not having environmental stability and cleanability at the same time.

### SUMMARY OF THE INVENTION

The present invention aims to solve the above problems in the art and achieve the following objects. That is, an object of the present invention is to provide a toner excellent in both low-temperature fixing property and heat resistance to be superior in environmental stability, and less frequently forming abnormal images due to cleaning failures.

Means for solving the above problems are as follows.

That is, a toner of the present invention includes:

a binder resin; and

a colorant;

wherein the toner is obtained by dispersing or emulsifying an oil phase in an aqueous solvent containing an organic sulfonic acid salt and an inorganic salt, the oil phase containing the binder resin and the colorant dissolved or dispersed in an organic solvent,

wherein the binder resin contains a crystalline resin in an amount of 50% by mass or more relative to the binder resin, and

wherein the toner has an average circularity of 0.980 or less.

The present invention can provide a toner excellent in both low-temperature fixing property and heat resistance to be superior in environmental stability, and less frequently forming abnormal images due to cleaning failures. The toner of the present invention can solve the above problems in the art and achieve the above object.

### BRIEF DESCRIPTION OF THE DRAWINGS

FIG. 1 is a schematic configuration view of one example of an image forming apparatus of the present invention.

FIG. 2 is a schematic configuration view of another example of an image forming apparatus of the present invention.

FIG. 3 is a schematic configuration view of still another example of an image forming apparatus of the present invention.

FIG. 4 is an enlarged view of a part of the image forming apparatus of FIG. 3.

### DETAILED DESCRIPTION OF THE INVENTION

### Toner

A toner of the present invention is obtained by dispersing or emulsifying an oil phase in an aqueous solvent containing an organic sulfonic acid salt and an inorganic salt, the oil phase containing at least a binder resin and a colorant dispersed or emulsified in an organic solvent.

The toner contains at least a binder resin and a colorant; and, if necessary, further contains other ingredients.

### <Oil Phase>

The oil phase is not particularly limited and may be appropriately selected depending on the intended purpose so long as it is prepared by dissolving or dispersing a binder resin and a colorant in an organic solvent.

### <<Binder Resin>>

The binder resin contains at least a crystalline resin in an amount of 50% by mass or more relative to the binder resin; and, if necessary, further includes other ingredients.

### —Crystalline Resin—

The crystalline resin is not particularly limited and may be appropriately selected depending on the intended purpose so long as it has crystallinity. Examples thereof include polyester resins, polyurethan resins and polyurea resins.

The crystalline resin may be modified or unmodified but is preferably a modified crystalline resin in terms of heat resistance storageability. Hereinafter, the crystalline resin which has been modified is referred to as a modified crystalline resin.

A method for measuring the crystallinity of the crystalline resin is, for example, a method using a differential scanning calorimeter. Note that, in the differential scanning calorimeter, the crystalline resin exhibits the maximal endothermic amount at the melting point thereof, while a non-crystalline resin exhibits a smooth curve based on glass transition.

The melting point (Tm) of the crystalline resin is not particularly limited and may be appropriately selected depending on the intended purpose, but is preferably 50° C. to 70° C., more preferably 55° C. to 65° C. When the melting point thereof is lower than 50° C., the obtained toner particles may deform under high-temperature conditions such as in midsummer, so that they adhere to each other and cannot behave as particles in some cases. When the melting point thereof is higher than 70° C., the obtained toner particles are degraded in fixing property.

The weight average molecular weight (Mw) of the crystalline resin is not particularly limited and may be appropriately selected depending on the intended purpose, but is preferably 10,000 to 40,000, more preferably 15,000 to 35,000, particularly preferably 20,000 to 30,000. A crystalline resin having a weight average molecular weight of less than 10,000 may degrade the toner in heat resistance storageability. A crystalline resin having a weight average molecular weight of higher than 40,000 may degrade the toner in low-temperature fixing property.

The amount of the crystalline resin in the binder resin is not particularly limited and may be appropriately selected depending on the intended purpose so long as it is 50% by mass or more. It is preferably 60% by mass or more, more preferably 65% by mass or more. Note that, when the amount of the crystalline resin is 50% by mass or more, the toner can be excellent in both low-temperature fixing property and heat resistance storageability.

### —Polyester Resin—

The polyester resin is generally obtained as a polycondensate of a polyol and polycarboxylic acid.

The polyol is not particularly limited and may be appropriately selected depending on the intended purpose, but is preferably an aliphatic diol.

The aliphatic diol is not particularly limited and may be appropriately selected depending on the intended purpose. Examples thereof include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol, 1,10-decanediol and 1,9-nonanediol.

Among them, 1,4-butenediol, 1,6-hexanediol and 1,8-octanediol are preferred, and 1,6-hexanediol, ethylene glycol, 1,10-decanediol and 1,9-nonanediol are more preferred.

The polycarboxylic acid is not particularly limited and may be appropriately selected depending on the intended purpose. Examples thereof include aromatic dicarboxylic acids and aliphatic dicarboxylic acids. Among them, C2-C12 aromatic dicarboxylic acids and C2-C12 aliphatic dicarboxylic acids are preferred. From the viewpoint of increasing crystallinity, C2-C12 aliphatic dicarboxylic acids are more preferred.

The C2-C12 aromatic dicarboxylic acid is not particularly limited and may be appropriately selected depending on the intended purpose. Examples thereof include isophthalic acid and terephthalic acid.

The C2-C12 aliphatic dicarboxylic acid is not particularly limited and may be appropriately selected depending on the intended purpose. Examples thereof include adipic acid and 1,10-dodecanedioic acid.

### —Polyurea Resin—

The polyurea resin is generally a resin formed through reaction between a polyamine component and a polyisocyanate component.

The polyamine component is not particularly limited and may be appropriately selected depending on the intended purpose. Examples thereof include diamine components and tri- or higher functional amine components.

The polyisocyanate component is not particularly limited and may be appropriately selected depending on the intended purpose. Examples thereof include diisocyanate components and tri- or higher functional isocyanate components.

### —-Diamine Component—

The diamine component is not particularly limited and may be appropriately selected depending on the intended purpose. Examples thereof include aliphatic diamines and aromatic diamines. Among them, preferred are C2-C18 aliphatic diamines and C6-C20 aromatic diamines.

The C2-C18 aliphatic diamine is not particularly limited and may be appropriately selected depending on the intended purpose. Examples thereof include C2-C6 alkylenediamines, C4-C18 polyalkylenediamines, C1-C4 alkyl-substituted diamines, C2-C4 hydroxyalkyl-substituted diamines, alicyclic or heterocyclic ring-containing aliphatic diamines and C8-C15 aromatic ring-containing aliphatic diamines.

The C2-C6 alkylenediamine is not particularly limited and may be appropriately selected depending on the intended purpose. Examples thereof include ethylenediamine, propylenediamine, trimethylenediamine, tetramethylenediamine and hexamethylenediamine.

The C4-C18 polyalkylenediamine is not particularly limited and may be appropriately selected depending on the intended purpose. Examples thereof include hexylene diamine, octylene diamine, decylene diamine and dodecylene diamine.

The C1-C4 alkyl-substituted diamine is not particularly limited and may be appropriately selected depending on the intended purpose. Examples thereof include dialkylaminopropylamine, trimethylhexamethylenediamine, 2,5-dimethyl-2,5-hexamethylenediamine and methyliminobispropylamine.

The C2-C4 hydroxyalkyl-substituted diamine is not particularly limited and may be appropriately selected depending on the intended purpose. Examples thereof include aminoethylethanolamine.

The alicyclic or heterocyclic ring-containing aliphatic diamine is not particularly limited and may be appropriately selected depending on the intended purpose. Examples thereof include C4-C15 alicyclic diamines and C4-C15 heterocyclic diamines.

The C4-C15 alicyclic diamine is not particularly limited and may be appropriately selected depending on the intended purpose. Examples thereof include 1,3-diaminocyclohexane, isophorone diamine, menthenediamine and 4,4′-methylenedichylohexanediamine.

The C4-C15 heterocyclic diamine is not particularly limited and may be appropriately selected depending on the intended purpose. Examples thereof include piperazine, N-aminoethylpiperazine, 1,4-diaminoethylpiperazine, 1,4-bis(2-amino-2-methylpropyl)piperazine and 3,9-bis(3-aminopropyl)-2,4,8,10-tetraoxaspiro[5,5]undecane.

The C8-C15 aromatic ring-containing aliphatic diamine is not particularly limited and may be appropriately selected depending on the intended purpose. Examples thereof include xylylenediamine and tetrachloro-p-xylylenediamine.

The C6-C20 aromatic diamine is not particularly limited and may be appropriately selected depending on the intended purpose. Examples thereof include unsubstituted aromatic diamines, aromatic diamines having a C1-C4 nuclear-substituted alkyl group, aromatic diamines having a nuclear substituted electron-attracting group, and aromatic diamines having a secondary amino group.

The unsubstituted aromatic diamine is not particularly limited and may be appropriately selected depending on the intended purpose. Examples thereof include 1,2-phenylenediamine, 1,3-phenylenediamine, 1,4-phenylenediamine, 2,4′-diphenylmethanediamine, 4,4′-diphenylmethanediamine, crude diphenylmethanediamine, diaminodiphenyl sulfone, benzidine, thiodianiline, bis(3,4-diaminophenyl)sulfone, 2,6-diaminopyridine, m-aminobenzylamine, triphenylmethane-4,4′,4″-triamine and naphthylenediamine.

The aromatic diamines having a C1-C4 nuclear-substituted alkyl group is not particularly limited and may be appropriately selected depending on the intended purpose. Examples thereof include 2,4-triethylenediamine, 2,6-triethylenediamine, crude tolylenediamine, diethyltolylenediamine, 4,4′-diamino-3,3′-dimethyldiphenylmethane, 4,4′-bis(o-toluidine), dianisidine, diaminoditolyl sulfone, 1,3-dimethyl-2,4-diaminobenzene, 1,3-dimethyl-2,6-diaminobenzene, 1,4-diisopropyl-2,5-diaminobenzene, 2,4-diaminomesitylene, 1-methyl-3,5-diethyl-2,4-diaminobenzene, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenylmethane, 3,5-diethyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraethyl-4,4′-diamino diphenyl ether and 3,3′,5,5′-tetraisopropyl-4,4′-diaminodiphenyl sulfone.

The aromatic diamine having a nuclear substituted electron-attracting group is not particularly limited and may be appropriately selected depending on the intended purpose. Examples thereof include methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline, 4,4′-diamino-3,3′-dimethyl-5,5′-dibromo-diphenylmethane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylenebis(2-iodoaniline), 4,4′-methylenebis(2-bromoaniline), 4,4′-methylenebis(2-fluoroaniline) and 4-aminophenyl-2-chloroaniline.

The aromatic diamine having a secondary amino group is not particularly limited and may be appropriately selected depending on the intended purpose. Examples thereof include 4,4′-di(methylamino)diphenylmethane and 1-methyl-2-methylamino-4-aminobenzene.

### —Tri- or Higher Functional Amine Component—

The tri- or higher functional amine component is not particularly limited and may be appropriately selected depending on the intended purpose. Examples thereof include diethylenetriamine, iminobispropylamine, bis(hexamethylene)triamine, triethylenetetramine, tetraethylenepentamine, pentaethylenehexamine, polyamide polyamine and polyether polyamine.

### —Diisocyanate Component—

The diisocyanate component is not particularly limited and may be appropriately selected depending on the intended purpose. Examples thereof include aliphatic diisocyantes, alicyclic diisocyantes, aromatic diisocyantes and aromatic-aliphatic diisocyantes. Further examples thereof include compounds formed by blocking at least one isocyanate group of the above diisocyanate component with, for example, a phenol derivative, oxime or caprolactam.

The aliphatic diisocyanate is not particularly limited and may be appropriately selected depending on the intended purpose. Examples thereof include tetramethylene diisocyanate, hexamethylene diisocyanate and 2,6-diisocyanato methylcaproate.

The alicyclic diisocyante is not particularly limited and may be appropriately selected depending on the intended purpose. Examples thereof include isophorone diisocyanate and cyclohexylmethane diisocyanate.

The aromatic diisocyante is not particularly limited and may be appropriately selected depending on the intended purpose. Examples thereof include tolylene diisocyanate, diphenylmethane diisocyanate and α,α,α′,α′-tetramethylxylylene diisocyanate.

### —Modified Crystalline Resin—

The modified crystalline resin is not particularly limited and may be appropriately selected depending on the intended purpose. Examples thereof include urethane-modified polyester resins where the above polyester resins are modified with the above diisocyanate components.

The amount of the modified crystalline resin in the binder resin is not particularly limited and may be appropriately selected depending on the intended purpose. It is preferably 20% by mass or less, more preferably 15% by mass or less, particularly preferably 10% by mass or less, relative to the entire binder resin. When the amount of the modified binder resin is more than 20% by mass, the formed toner may be degraded in low-temperature fixing property.

### <<Colorant>>

The colorant is not particularly limited and may be appropriately selected depending on the intended purpose. Examples thereof include carbon black, nigrosine dye, iron black, naphthol yellow S, Hansa yellow 10G, Hansa yellow 5G, Hansa yellow G, cadmium yellow, yellow iron oxide, yellow ocher, yellow lead, titanium yellow, polyazo yellow, oil yellow, Hansa yellow GR, Hansa yellow A, Hansa yellow RN, Hansa yellow R, pigment yellow L, benzidine yellow G, benzidine yellow GR, permanent yellow NCG, vulcan fast yellow 5G, vulcan fast yellow R, tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower and lithopone. These may be used alone or in combination. Also, known dyes and pigments may be used in combination.

The amount of the colorant in the toner is not particularly limited and may be appropriately selected depending on the intended purpose. It is preferably 1% by mass to 15% by mass, more preferably 3% by mass to 10% by mass.

### <<Organic Solvent>>

The organic solvent is not particularly limited and may be appropriately selected depending on the intended purpose. It is preferably a volatile organic solvent having a boiling point of lower than 100° C. since the solvent can easily be removed.

The volatile organic solvent having a boiling point of lower than 100° C. is not particularly limited and may be appropriately selected depending on the intended purpose. Examples thereof include aromatic solvents, halogenated hydrocarbon solvents and ester solvents.

The aromatic solvent is not particularly limited and may be appropriately selected depending on the intended purpose. Examples thereof include toluene and xylene.

The halogenated hydrocarbon solvent is not particularly limited and may be appropriately selected depending on the intended purpose. Examples thereof include methylene chloride, 1,2-dichloroethane, chloroform and carbon tetrachloride.

The ester solvent is not particularly limited and may be appropriately selected depending on the intended purpose. Examples thereof include methyl acetate and ethyl acetate.

### —Other Ingredients—

The other ingredients in the binder resin are not particularly limited and may be appropriately selected depending on the intended purpose. The binder resin preferably contains a non-crystalline resin from the viewpoints of, for example, heat resistance storageability and chargeability.

When the above crystalline resin is referred to as a first crystalline resin, the binder resin preferably contains a second crystalline resin having a molecular weight greater than that of the first crystalline resin from the viewpoint of heat resistance storageability. Note that, when the second crystalline resin is contained in the binder resin, the amount in % by mass of the crystalline resin in the binder resin is a total amount in % by mass of the first and second crystalline resins in the binder resin.

### —Non-Crystalline Resin—

The non-crystalline resin is not particularly limited and may be appropriately selected from known resins depending on the intended purpose so long as it is non-crystalline. Examples thereof include: polymers of styrene or substituted products thereof such as polystyrenes, poly-p-styrenes and polyvinyltoluenes; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylic acid copolymers, styrene-methyl methacrylate copolymers, styrene-ethyl methacrylate copolymers, styrene-acrylonitrile copolymers, styrene-vinyl methyl ether copolymers, styrene-vinyl methyl ketone copolymers, styrene-butadiene copolymers, styrene-isopropyl copolymers and styrene-maleic acid ester copolymers; polymethyl methacrylate resins; polybutyl methacrylate resins; polyvinyl chloride resins; polyvinyl acetate resins; polyethylene resins; polyester resins; polyurethane resins; epoxy resins; polyvinyl butyral resins; polyacrylic acid resins; modified rosin resins; terpene resins; phenol resins; aliphatic or alicyclic hydrocarbon resins; aromatic petroleum resins; and modified products of the above resins which are modified so as to have a functional group reactive with an active hydrogen group. These may be used alone or in combination.

### —Second Crystalline Resin—

The second crystalline resin is not particularly limited and may be appropriately selected depending on the intended purpose so long as it is crystalline. It is preferably a crystalline resin having a urethane or urea bond in a backbone thereof.

The second crystalline resin having a urethane or urea bond in a backbone thereof is not particularly limited and may be appropriately selected depending on the intended purpose. It is preferably a crystalline resin formed by extending a crystalline resin precursor having an isocyanate group at an end thereof.

A method for extending the crystalline resin precursor is not particularly limited and may be appropriately selected depending on the intended purpose. From the viewpoint of controlling viscoelasticity, it is preferably a method where the crystalline resin precursor having an isocyanate group at an end thereof is mixed with an extending agent such as an amine reactive to the isocyanate group thereof, and chain extention is performed during or after formation of particles and then is terminated with a terminating agent.

The crystalline resin precursor is not particularly limited and may be appropriately selected depending on the intended purpose. Examples thereof include reaction products between polyesters having an active hydrogen group and polyisocyanates.

The polyester is not particularly limited and may be appropriately selected depending on the intended purpose so long as it has an active hydrogen group. Examples thereof include reaction products between polyols and polycarboxylic acids.

The polyol is not particularly limited and may be appropriately selected depending on the intended purpose. Examples thereof include similar ones to the polyols exemplified regarding the crystalline polyester resin.

The polycarboxylic acid is not particularly limited and may be appropriately selected depending on the intended purpose. Examples thereof include similar ones to the polycarboxylic acids exemplified regarding the crystalline polyester resin.

The active hydrogen group is not particularly limited and may be appropriately selected depending on the intended purpose. Examples thereof include alcoholic hydroxyl groups, phenolic hydroxyl groups, an amino group, a carboxyl group and a mercapto group. Among them, alcoholic hydroxyl groups are preferred from the viewpoint of reactivity.

The polyisocyanate is not particularly limited and may be appropriately selected depending on the intended purpose. Examples thereof include similar ones to the above diisocyanate components.

A ratio of the isocyanate group [NCO] in the crystalline resin precursor to the hydroxyl group [OH] in the binder resin is expressed as an equivalent ratio [NCO]/[OH].

The equivalent ratio [NCO]/[OH] is not particularly limited and may be appropriately selected depending on the intended purpose, but is preferably 5/1 to 1/1, more preferably 4/1 to 1.2/1, particularly preferably 2.5/1 to 1.5/1. When the [NCO] is less than one equivalent relative to one equivalent of the [OH], the toner may be degraded in heat resistance storageability. When the [NCO] is more than five equivalents relative to one equivalent of the [OH], the toner may be degraded in low-temperature fixing property.

The amount of the polyisocyanate relative to the crystalline resin precursor having the isocyanate group is not particularly limited and may be appropriately selected depending on the intended purpose, but is preferably 0.5% by mass to 40% by mass, more preferably 1% by mass to 30% by mass, particularly preferably 2% by mass to 20% by mass. When it is less than 0.5% by mass, the toner may be degraded in heat resistance storageability. When it is more than 40% by mass, the toner may be degraded in low-temperature fixing property.

The average number of the isocyanate groups in one molecule of the crystalline resin precursor is not particularly limited and may be appropriately selected depending on the intended purpose, but is preferably one or more, more preferably 1.5 to 3, particularly preferably 1.8 to 2.5. When the average number thereof is less than one, the toner may be degraded in heat resistance storageability.

The extending agent is not particularly limited and may be appropriately selected depending on the intended purpose. Examples thereof include amines.

The amine is not particularly limited and may be appropriately selected depending on the intended purpose. Examples thereof include diamines, tri- or higher polyamines, aminoalcohols, aminomercaptanes and amino acids.

The diamine is not particularly limited and may be appropriately selected depending on the intended purpose. Examples thereof include aromatic diamines, alicyclic diamines and aliphatic diamines.

The aromatic diamine is not particularly limited and may be appropriately selected depending on the intended purpose. Examples thereof include phenylene diamine, diethyltoluene diamine, 4,4′-diaminodiphenylmethane, tetrafluoro-p-xylylenediamine and tetrafluoro-p-phenylenediamine.

The alicyclic diamine is not particularly limited and may be appropriately selected depending on the intended purpose. Examples thereof include 4,4′-diamino-3,3′-dimethyldicyclohexylmethane, diaminecyclohexane and isophorondiamine.

The aliphatic diamine is not particularly limited and may be appropriately selected depending on the intended purpose. Examples thereof include ethylenediamine, tetramethylenediamine, hexamethylenediamine, dodecafluorohexylenediamine and tetracosafluorododecylenediamine.

The tri- or higher polyamine is not particularly limited and may be appropriately selected depending on the intended purpose. Examples thereof include diethylenetriamine and triethylenetetramine.

The aminoalcohol is not particularly limited and may be appropriately selected depending on the intended purpose. Examples thereof include ethanolamine and hydroxyethylaniline.

The aminomercaptan is not particularly limited and may be appropriately selected depending on the intended purpose. Examples thereof include aminoethylmercaptan and aminopropylmercaptan.

The amino acid is not particularly limited and may be appropriately selected depending on the intended purpose. Examples thereof include aminopropionic acid and aminocaproic acid.

The terminating agent is not particularly limited and may be appropriately selected depending on the intended purpose so long as it can terminate the extension reaction to control the molecular weight of the product. Examples thereof include monoamines and ketimine compounds where the monoamines are blocked.

The monoamine is not particularly limited and may be appropriately selected depending on the intended purpose. Examples thereof include diethylamine, dibutylamine, butylamine and laurylamine.

A ratio of the isocyanate group to the amine is not particularly limited and may be appropriately selected depending on the intended purpose. Regarding the ratio of the isocyanate group to the amine, an equivalent ratio [NCO]/[NHx] of the isocyanate group [NCO] to the amino group [NHx] in the amine, the equivalent ratio [NCO]/[NHx] is preferably 1/2 to 2/1, more preferably 1.5/1 to 1/1.5, particularly preferably 1.2/1 to 1/1.2. When the [NCO]/[NHx] is more than 2/1 or less than ½, the toner may be degraded in heat resistance storageability.

The weight average molecular weight (Mw) of the second crystalline resin is not particularly limited and may be appropriately selected depending on the intended purpose, but is preferably 40,000 to 300,000, more preferably 50,000 to 150,000. When the weight average molecular weight (Mw) thereof is lower than 40,000, the toner may be prevented from being improved in heat resistance storageability. When it is higher than 300,000, the toner does not sufficiently melt during fixing at low temperatures, and the toner may be degraded in low-temperature fixing property to easily cause abrasion of an image.

The difference in weight average molecular weight (Mw) between the first crystalline resin and the second crystalline resin is not particularly limited and may be appropriately selected depending on the intended purpose, but is preferably 5,000 or greater, more preferably 10,000 or greater. When the above difference is smaller than 5,000, the fixable range of the toner may be narrowed, potentially preventing the toner from being improved in heat resistance storageability.

The amount of the second crystalline resin relative to the first crystalline resin in the above toner is not particularly limited and may be appropriately selected depending on the intended purpose, but is preferably 5% by mass to 30% by mass. When it is less than 5% by mass, the toner may be prevented from being improved in heat resistance storageability. When it is more than 30% by mass, the toner may be degraded in low-temperature fixing property.

A ratio of Tsh2nd/Tshlst of a shoulder temperature Tsh2nd in the peak of the heat of fusion in the second temperature raising to a shoulder temperature Tshlst in the peak of the heat of fusion in the first temperature raising as obtained by measuring the toner with a differential scanning calorimeter (DSC) is not particularly limited and may be appropriately selected depending on the intended purpose, but is preferably 0.90 to 1.10.

The shoulder temperature (Tsh1st or Tsh2nd) in the peak of the heat of fusion of the toner is measured using, for example, a differential scanning calorimeter (DSC).

Viscoelastic properties of the toner are not particularly limited and may be appropriately selected depending on the intended purpose. From the viewpoints of fixing strength and heat resistance storageability, the toner preferably has a storage modulus G′(70) (Pa) at 70° C. of more than 5.0×10⁴ Pa but less than 5.0×10⁵ Pa, and has a storage modulus G′(160) (Pa) at 160° C. of more than 1.0×10³ Pa but less than 1.0×10⁴ Pa.

The storage modulus may be measured using, for example, a dynamic viscoelasticity measuring device.

### <Aqueous Phase>

The aqueous phase in the present invention is not particularly limited and may be appropriately selected depending on the intended purpose so long as it contains an aqueous solvent containing an organic sulfonic acid salt and an inorganic salt.

### <<Organic Sulfonic Acid Salt>>

The organic sulfonic acid salt is not particularly limited and may be appropriately selected depending on the intended purpose, but is preferably an alkyl group-containing sulfonic acid salt represented by the following General Formula (1), an alkyl group-containing sulfonic acid salt represented by the following General Formula (2), or an alkyl group-containing sulfonic acid salt represented by the following General Formula (3), or any combination thereof:

CₙH₂ₙ₊₁—R¹—SO₃M General Formula (1)

CₙH₂ₙ₊₁—R¹(SO₃M)-O—R²⁻SO₃M General Formula (2)

CₙH₂ₙ₊₁—SO₃M General Formula (3)

In General Formulas (1), (2) and (3), n is an integer of 10 to 18, R¹ is a phenyl group, R² is a phenyl group or an alkylene group, and M is a monovalent metal.

Note that, the phenyl group denoted by R¹ in General Formula (1) is a divalent phenyl group. The phenyl group denoted by R¹ in General Formula (2) is a trivalent phenyl group. The phenyl group denoted by R² in General Formula (2) is a divalent phenyl group.

The alkyl group is not particularly limited and may be appropriately selected depending on the intended purpose, but is preferably a C5-C30 alkyl group.

The monovalent metal is not particularly limited and may be appropriately selected depending on the intended purpose, but is preferably an alkali metal.

The alkali metal is not particularly limited and may be appropriately selected depending on the intended purpose, but is preferably sodium or potassium since they are easily available.

### <<Inorganic Salt>>

The inorganic salt is not particularly limited and may be appropriately selected depending on the intended purpose so long as it can dissolve in water, but is preferably a salt composed of a cation and an anion.

The cation is not particularly limited and may be appropriately selected depending on the intended purpose, but is preferably Na⁺, Mg²⁺, K⁺, Ca²⁺, or NR⁴⁺ (where R is H or a C1-C4 alkyl group).

The anion is not particularly limited and may be appropriately selected depending on the intended purpose, but is preferably Cl⁻, Br⁻, NO₃⁻, HCO₃⁻, CO₃²⁻, HSO₄⁻, SO₄²⁻, H₂PO₄⁻, HPO₄²⁻ or PO₄³⁻.

The salt composed of the cation and the anion is not particularly limited and may be appropriately selected depending on the intended purpose. Examples thereof include magnesium chloride, sodium chloride, ammonium chloride, calcium phosphate, sodium phosphate, potassium sulfate and potassium nitrate. Among them, magnesium chloride and sodium chloride are preferred since they have an effect of causing aggregation and easily available.

### <<Aqueous Solvent>>

The aqueous solvent is water alone or a mixture of water and a water-miscible solvent.

The water-miscible solvent is not particularly limited and may be appropriately selected depending on the intended purpose. Examples thereof include alcohols, cellsolves, lower ketones, dimethylformamide and tetrahydrofuran.

The alcohol is not particularly limited and may be appropriately selected depending on the intended purpose. Examples thereof include methanol, isopropanol and ethylene glycol.

The cellsolve is not particularly limited and may be appropriately selected depending on the intended purpose. Examples thereof include methyl cellsolve.

The lower ketone is not particularly limited and may be appropriately selected depending on the intended purpose. Examples thereof include acetone and methyl ethyl ketone.

The amount of the aqueous solvent used is not particularly limited and may be appropriately selected depending on the intended purpose, but is preferably 50 parts by mass to 2,000 parts by mass, more preferably 100 parts by mass to 1,000 parts by mass, per 100 parts by mass of the binder resin.

### <Other Ingredients>

The other ingredients in the toner are not particularly limited and may be appropriately selected depending on the intended purpose. Examples thereof include a releasing agent, a releasing agent disperser, a modified layered inorganic mineral, an external additive and a cleaning aid.

### —Releasing Agent—

The releasing agent used in the present invention is not particularly limited and may be appropriately selected depending on the intended purpose. Examples thereof include polyolefin wax, long-chain hydrocarbons and carbonyl group-containing wax.

The polyolefin wax is not particularly limited and may be appropriately selected depending on the intended purpose. Examples thereof include polyethylene wax and polypropylene wax.

The long-chain hydrocarbon is not particularly limited and may be appropriately selected depending on the intended purpose. Examples thereof include paraffin wax, Fischer-Tropsch wax and Sasol wax.

Examples of the carbonyl group-containing wax include polyalkanoic acid esters, polyalkanol esters, polyalkanoic acid amides, polyalkylamides and dialkyl ketone.

Among them, polyolefin wax and long-chain hydrocarbons are preferred, and paraffin wax and Fischer-Tropsch wax are more preferred, since they have low polarity and low melt viscosity.

### —Releasing Agent Disperser—

The releasing agent disperser is not particularly limited and may be appropriately selected depending on the intended purpose so long as it assists dispersion of the releasing agent. Examples thereof include polymers and oligomers containing unit (A) having high compatibility to the releasing agent and unit (B) having high compatibility to the binder resin in a blocked form. Examples thereof include polymers and oligomers where one of the unit (A) having high compatibility to the releasing agent and the unit (B) having high compatibility to the binder resin is grafted to the other unit.

The unit (A) is not particularly limited and may be appropriately selected depending on the intended purpose. Examples thereof include unsaturated hydrocarbons such as ethylene, propylene, butene, styrene and α-styrene.

The unit (B) is not particularly limited and may be appropriately selected depending on the intended purpose. Examples thereof include α,β-unsaturated carboxylic acids such as acrylic acid, methacrylic acid, methyl methacrylate, maleic acid and itaconic acid. The α,β-unsaturated carboxylic acids may be esters or anhydrides thereof.

### —Modified Layered Inorganic Mineral—

The modified layered inorganic mineral is generally a layered inorganic mineral containing interlayer ions at least one of which has been modified with organic ions.

The modified layered inorganic mineral is not particularly limited and may be appropriately selected depending on the intended purpose. Examples thereof include reaction products between organic cation modifiers and layered inorganic minerals such as montmorillonite, bentonite, hectorite, attapulgite and sepiolite. These may be used alone or in combination.

Among them, reaction products between organic cation modifiers and montmorillonite or bentonite are preferred since they do not adversely affect properties of the obtained toner. In addition, the viscosity of the toner can easily be adjusted and the amount of them can be made small.

As for the modified layered inorganic mineral, commercial available products may be used. Examples of the commercial available products thereof include: BENTONE 3, BENTONE 38, BENTONE 38V (there products are of Rheox Co., Ltd.); TIXOGEL VP (product of United catalyst Co., Ltd.), CLAYTONE 34, CLAYTONE 40, CLAYTONE XL (there products are of Southern Clay Products Inc.); BENTONE 27 (product of Rheox Co., Ltd.), TIXOGEL LG (product of United Catalyst Co., Ltd.), CLAYTONE AF, CLAYTONE APA (these products are of Southern Clay Products Inc.); CLAYTONE HT and CLAYTONE PS (these products are of Southern Clay Products Inc.). These may be used alone or in combination.

Among them, CLAYTONE AF and CLAYTONE APA are preferred since they do not adversely affect properties of the obtained toner. In addition, the viscosity of the toner can easily be adjusted and the amount of them can be made small.

The organic ion modifier is not particularly limited and may be appropriately selected depending on the intended purpose. Examples thereof include quaternary alkyl ammonium salts, phosphonium salts and imidazolium salts. Among them, quaternary alkyl ammonium salts are preferred since they are generally used and easily available.

The quaternary alkyl ammonium salt is not particularly limited and may be appropriately selected depending on the intended purpose. Examples thereof include trimethylstearyl ammonium, dimethylstearylbenzyl ammonium and oleylbis(2-hydroxyethyl)methyl ammonium.

The amount of the modified layered inorganic mineral in the toner is not particularly limited and may be appropriately selected depending on the intended purpose. From the viewpoint of deformation of a toner, it is preferably 0.05% by mass to 10% by mass, more preferably 0.05% by mass to 5% by mass.

### —External Additive—

The external additive is not particularly limited and may be appropriately selected depending on the intended purpose. Examples thereof include inorganic particles and polymer particles. Among them, inorganic particles are preferred from the viewpoint of assisting the obtained colored particles in flowability, developability and chargeability. Also, when a surface treating agent is added to the external additive to increase its hydrophobic property, it is possible to prevent degradation in flowability and chargeability even under high-humidity conditions.

### —Inorganic Particles—

The inorganic particles are not particularly limited and may be appropriately selected depending on the intended purpose. Examples thereof include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride.

The primary particle diameter of the inorganic particles is not particularly limited and may be appropriately selected depending on the intended purpose, but is preferably 5 nm to 2 μm, more preferably 5 nm to 500 nm.

The structure of the inorganic particles is not particularly limited and may be appropriately selected depending on the intended purpose. The inorganic particles preferably have a specific surface area as measured by the BET method of 20 m²/g to 500 m²/g.

The amount of the inorganic particles is not particularly limited and may be appropriately selected depending on the intended purpose, but is preferably 0.01% by mass to 5% by mass, more preferably 0.01% by mass to 2.0% by mass, relative to the amount of the toner.

### —Polymer Particles—

The polymer particles are not particularly limited and may be appropriately selected depending on the intended purpose. Examples thereof include polystyrene particles and polymethyl methacrylate particles.

### —Surface Treating Agent—

The surface treating agent is not particularly limited and may be appropriately selected depending on the intended purpose. Examples thereof include a silane coupling agent, a silylating agent, a fluorinated alkyl group-containing silane coupling agent, an organic titanate coupling agent, an aluminum coupling agent, silicone oil and modified silicone oil.

### —Cleaning Aid—

The cleaning aid is not particularly limited and may be appropriately selected depending on the intended purpose so long as it removes the toner after transfer remaining on a photoconductor or a primary transfer medium to thereby improve their cleanability. Examples thereof include fatty acid metal salts and polymer particles. The polymer particles are not particularly limited and may be appropriately selected depending on the intended purpose. The polymer particles preferably have a volume average particle diameter of 0.01 μm to 1 μm since the particle size distribution thereof is relatively narrow.

The fatty acid metal salt is not particularly limited and may be appropriately selected depending on the intended purpose. Examples thereof include zinc stearate and calcium stearate.

The polymer particles are not particularly limited and may be appropriately selected depending on the intended purpose. Examples thereof include similar polymer particles to those for the above external additive.

The volume average particle diameter of the toner is not particularly limited and may be appropriately selected depending on the intended purpose. It is preferably 3 μm to 9 μm, more preferably 4 μm to 8 μm, particularly preferably 4 μm to 7 μm, since the toner is charged uniformly and sufficiently. When the volume average particle diameter thereof is less than 3 μm, the adhesion force of the toner increases relatively and the handleability of the toner by an electrical field decreases. When it is more than 9 μm, there may be degradation in image qualities such as reproducibility of thin lines.

Also, a ratio of the volume average particle diameter of the toner to a number average particle diameter (volume average particle diameter/number average particle diameter) is not particularly limited and may be appropriately selected depending on the intended purpose, but is preferably 1.25 or less, more preferably 1.20 or less, particularly preferably 1.17 or less. When the above ratio is more than 1.25, the toner has degraded uniformity in particle diameter. During repeated development, larger toner particles or smaller toner particles are consumed to change the average particle diameter of the toner particles remaining in a developing device. The optimal conditions for developing the remaining toner particles are changed, so that various unfavorable phenomena tend to occur such as charging failure, extreme increase or decrease in amount of the toner particles conveyed, clogging of the toner particles, and scattering of the toner particles.

A method for measuring the particle size distribution of the toner is a method using, for example, COULTER COUNTER TA-II or COULTER MULTISIZER II.

### <Average Circularity>

The average circularity of the toner is not particularly limited and may be appropriately selected depending on the intended purpose so long as it is 0.980 or less. The average circularity thereof is preferably 0.950 to 0.975, more preferably 0.960 to 0.975. When the average circularity is less than 0.950, the toner tends to cause unfavorable phenomena in development due to its low flowability. When it is more than 0.975, the toner may be degraded in cleanability.

A method for measuring the average circularity is a method using, for example, a flow-type particle image analyzer.

### <Method for Producing a Toner>

A method of the present invention for producing a toner includes: an oil phase preparation step; an aqueous phase preparation step; a toner dispersion liquid preparation step; and a solvent removal step; and, if necessary, further includes other steps.

### —Oil Phase Preparation Step—

The oil phase preparation step is not particularly limited and may be appropriately selected depending on the intended purpose so long as it is a step of preparing an oil phase containing at least the binder resin and the colorant dissolved or dispersed in the organic solvent.

The method for preparing the oil phase is, for example, a method where at least the binder resin and the colorant and optionally added other ingredients such as the releasing agent are added to the organic solvent under stirring and dissolved or dispersed in the organic solvent. The concentration of the binder resin in the solution or the dispersion liquid is not particularly limited and may be appropriately selected depending on the intended purpose, but is preferably 40% by mass to 80% by mass. When it is more than 80% by mass, dissolving or dispersing may be difficult to perform. When it is less than 40% by mass, the amount of particles produced may be small and the amount of the solvent removed may be large.

When the crystalline polyester resin and the modified polyester resin having an isocyanate group at an end thereof is mixed together as the binder resin, they may be mixed as the same solution or dispersion liquid. Alternatively, a solution or dispersion liquid of the crystalline polyester resin and a solution or dispersion liquid of the modified polyester resin having an isocyanate group at an end thereof may be prepared separately. From the viewpoint of dissolvability and viscosity, the latter manner is preferred.

Forming the colorant into a masterbatch is one suitable means, and the similar method can be applied to the releasing agent also.

In another employable method, the releasing agent disperser is optionally added to the organic solvent, and the releasing agent and other ingredients are dispersed in a wet process to form a wet master.

After the colorant and the optional releasing agent which have been dispersed by the above method are dissolved or dispersed in the organic solvent together with the binder resin, the resultant liquid may further be dispersed. This dispersing can be performed using a known dispersing device such as a known beads mill or disc mill.

Also, in order to improve a toner obtained in mechanical strength and/or preventing hot offset during fixing, the toner is preferably produced in the oil phase where the polyester resin having a functional group reactive with the active hydrogen group of an active hydrogen group-containing compound is dissolved; i.e., in a state that the oil phase contains the polyester resin having a functional group reactive with the active hydrogen group of an active hydrogen group-containing compound.

Examples of the organic solvent used in the oil phase preparation step include those for the toner.

### —Aqueous Phase Preparation Step—

The aqueous phase preparation step is not particularly limited and may be appropriately selected depending on the intended purpose so long as it is a step of preparing an aqueous phase containing at least the organic sulfonic acid salt and the inorganic salt.

The aqueous solvent in the aqueous phase preparation step is not particularly limited and may be appropriately selected depending on the intended purpose. Examples of the aqueous solvent include those for the toner.

The amount of the organic sulfonic acid salt in the aqueous solvent is not particularly limited and may be appropriately selected depending on the intended purpose. The concentration of the organic sulfonic acid salt in the aqueous solvent is preferably 0.5% by mass to 10% by mass, more preferably 3% by mass to 10% by mass, still more preferably 4% by mass to 9% by mass, particularly preferably 5% by mass to 8% by mass. When it is less than 0.5% by mass, the oil droplets cannot be stably dispersed to form coarse oil droplets. When it is more than 10% by mass, each oil droplet becomes too small and also has a reverse micellar structure. Thus, the dispersion stability is degraded due to the organic sulfonic acid salt added in such an amount, potentially forming coarse oil droplets.

When the solution or dispersion of the binder resin, the colorant and the releasing agent is dispersed in the aqueous solvent, dispersing an inorganic disperser or organic resin particles are preferably dispersed in the aqueous solvent in advance since the particle size distribution becomes sharp and the dispersion state becomes stable.

The inorganic disperser is not particularly limited and may be appropriately selected depending on the intended purpose. Examples thereof include tricalcium phosphate, calcium carbonate, titanium oxide, colloidal silica and hydroxyapatite.

The resin of the organic resin particles is not particularly limited and may be appropriately selected depending on the intended purpose so long as it can form aqueous dispersion. Examples thereof include vinyl resins, polyurethan resins, epoxy resins, polyester resins, polyamide resins, polyimide resins, silicon resins, phenol resins, melamine resins, urea resins, aniliene resins, ionomer resins and polycarbonate resins. Among them, from the viewpoint of easily forming an aqueous dispersion of fine spherical resin particles, preferred are vinyl resins, polyurethan resins, epoxy resins and polyester resins.

Also, a protective colloid may be used to stabilize dispersed liquid droplets.

The protective colloid is not particularly limited and may be appropriately selected depending on the intended purpose. Examples thereof include acids, hydroxyl group-containing (meth)acrylic monomers, vinyl alcohol, ethers of vinyl alcohol, esters formed between vinyl alcohol and a carboxyl group-containing compound, acrylamides, methacrylamides, diacetoneacrylamides, acid chlorides, polyoxyethylenes, and celluloses. Further examples thereof include polymers of nitrogen-containing compounds and nitrogen-containing heterocyclic compounds such as vinyl pyridine, vinyl pyrrolidone, vinyl imidazole and ethyleneimine.

### —Toner Dispersion Liquid Preparation Step—

The toner dispersion liquid preparation step is not particularly limited and may be appropriately selected depending on the intended purpose so long as it is a step of dispersing the oil phase in the aqueous phase to prepare a toner dispersion liquid.

A method for dispersing the oil phase in the aqueous phase is not particularly limited and may be appropriately selected depending on the intended purpose. Examples thereof include a dispersion method using a known disperser such as a low-speed shearing disperser, a high-speed shearing disperser, a friction disperser, a high-pressure jet disperser or an ultrasonic disperser. Among them, dispersing using a high-speed shearing disperser is preferred in order to form dispersoids having a particle diameter of 2 μm to 20 μm.

The rotation speed of the high-speed shearing disperser is not particularly limited but is generally 1,000 rpm to 30,000 rpm, preferably 5,000 rpm to 20,000 rpm.

The time for the dispersing is not particularly limited and may be appropriately selected depending on the intended purpose. It is preferably 0.1 min to 5 min in a batch method. When the dispersion time exceeds 5 min, unfavorable small particles remain and excessive dispersion is performed to make the dispersion system unstable, potentially forming aggregates and coarse particles.

The temperature for the dispersing is not particularly limited and may be appropriately selected depending on the intended purpose. It is generally 0° C. to 40° C., preferably 10° C. to 30° C. When the dispersion temperature is lower than 0° C., the dispersion is increased in viscosity to require increased shearing energy for dispersing, potentially leading to a drop in production efficiency. When it exceeds 40° C., molecular movements are excited to degrade dispersion stability, potentially forming aggregates and coarse particles easily.

The amount of the organic solvent in the toner dispersion liquid is not particularly limited and may be appropriately selected depending on the intended purpose, but is preferably 10% by mass to 70% by mass, more preferably 25% by mass to 60% by mass, particularly preferably 40% by mass to 55% by mass.

When the amount of the organic solvent is less than 10% by mass, there may be a case where toner particles become large as a result of aggregation during emulsification. When it is more than 70% by mass, toner particles do not interact with each other well, making it impossible to make the toner particles have a desired particle size distribution.

Note that, the amount of the organic solvent in the toner dispersion liquid is an amount relative to that of solid matters in the state of the toner dispersion liquid (e.g., the binder resin, the colorant, and the optional releasing agent).

### —Solvent Removal Step—

The solvent removal step is not particularly limited and may be appropriately selected depending on the intended purpose so long as it is a step of removing the solvent in the toner dispersion liquid. It is preferably a step of completely removing the organic solvent in the toner dispersion liquid. In one employable means for removing the organic solvent therefrom, the toner dispersion liquid under stirring is gradually increased in temperature, to thereby completely evaporate off the organic solvent contained in the liquid droplets. In another employable means, the toner dispersion liquid under stirring is sprayed to a dry atmosphere, to thereby completely evaporate off the organic solvent contained in the liquid droplets. In still another employable means, the toner dispersion liquid is reduced in pressure under stirring to evaporate off the organic solvent. The latter two means may be used in combination with the first means.

The dry atmosphere to which the toner dispersion liquid is not particularly limited and may be appropriately selected depending on the intended purpose. It uses heated gas such as air, nitrogen, carbon dioxide and combustion gas.

The temperature of the dry atmosphere is not particularly limited and may be appropriately selected depending on the intended purpose. It is preferably a temperature equal to or higher than the highest boiling point of the solvents used.

The spraying is performed with, for example, a spray dryer, a belt dryer or a rotary kiln. Using them even in a short time can give a product having satisfactory quality.

### —Other Steps—

The other steps are not particularly limited and may be appropriately selected depending on the intended purpose. Examples thereof include an extending step, a washing step, a drying step and an external additive treatment step.

—Extending Step—

In order to incorporate a modified polyester resin having a urethane and/or urea group, when using a modified polyester resin having an isocyanate group at an end thereof and an amine reactive with the modified polyester resin, the amine may be added in the oil phase prior to dispersing a toner composition in the aqueous solvent, or may be added in the aqueous solvent.

The time required for the reaction is determined based on the structure of the isocyanate group of the polyester prepolymer and on the reactivity of the amine used, but is preferably 1 min to 40 hours, more preferably 1 hour to 24 hours. The reaction temperature is preferably 0° C. to 150° C., more preferably 20° C. to 98° C.

### —Washing Step—

The washing step is not particularly limited and may be appropriately selected depending on the intended purpose so long as it is a step of washing the toner (toner base particles) in the toner dispersion liquid after the solvent removal step or the extending step.

The toner dispersion liquid contains not only toner base particles but also subsidiary materials such as a disperser (e.g., a surfactant). Thus, washing is performed to take out only the toner base particles from the toner dispersion liquid.

A method for washing the toner base particles is not particularly limited and may be appropriately selected depending on the intended purpose. Examples thereof include a centrifugal separation method, a reduced-pressure filtration method and a filter press method. Any of the above methods forms a cake of the toner base particles. If the toner base particles are not sufficiently washed through only one washing process, the formed cake may be dispersed again in an aqueous medium to form a slurry, which is repeatedly treated with any of the above methods to take out the toner base particles. When a reduced-pressure filtration method or a filter press method is employed for washing, an aqueous solvent may be made to penetrate the cake to wash out the subsidiary materials contained in the toner base particles. The aqueous solvent used for washing is water or a solvent mixture of water and an alcohol such as methanol or ethanol. Use of water is preferred from the viewpoint of reducing cost and environmental load caused by, for example, drainage treatment.

### —Drying Step—

The drying step is not particularly limited and may be appropriately selected depending on the intended purpose so long as it is a step of drying the toner base particles after the washing step.

The washed toner base particles containing a large amount of water are dried to remove the water, whereby only the toner base particles can be obtained.

A method for removing water from the toner base particles is not particularly limited and may be appropriately selected depending on the intended purpose. Examples thereof include methods using dryers such as a spray dryer, a vacuum freezing dryer, a reduced-pressure dryer, a ventilation shelf dryer, a movable shelf dryer, a fluidized-bed-type dryer, a rotary dryer and a stirring-type dryer.

The toner base particles are preferably dried until the water content thereof is finally decreased less than 1% by mass. Also, when the dry toner base particles somewhat flocculate to cause inconvenience in use, the flocculated particles may be separated from each other through beating using, for example, a jet mill, HENSCHEL MIXER, a super mixer, a coffee mill, an oster blender or a food processor.

### —External Additive Treatment Step—

The resultant dry toner base particles may be mixed with other particles such as charge controllable particles and flowability improving particles, and also a mechanical impact may be applied to the powder mixture for immobilization or fusion of the other particles on the toner surface, to thereby prevent the other particles from dropping off from the surfaces of the toner particles. Examples of a method for applying a mechanical impact to the mixture include a method in which an impact is applied to a mixture using a high-speed rotating blade, and a method in which an impact is applied by putting mixed particles into a high-speed air flow and accelerating the air speed such that the particles collide against one another or that the particles are crashed into a proper collision plate. Examples of apparatus used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

### (Developer)

A developer of the present invention contains the toner of the present invention; and, if necessary, further contains appropriately selected other ingredients such as a carrier. The above developer may be a one-component developer or a two-component developer further containing a carrier. However, the two-component developer is preferred when used in, for example, high-speed printers responding to the recent improvements in data processing speed, since the service life of the two-component developer is prolonged.

### <Carrier>

The carrier is not particularly limited and may be appropriately selected depending on the intended purpose, but is preferably a carrier containing a core material and a resin layer covering the core material.

The material of the core material is not particularly limited and may be appropriately selected from known materials. For example, it is preferable to employ manganese-strontium (Mn—Sr) materials of 50 emu/g to 90 emu/g or manganese-magnesium (Mn—Mg) materials of 50 emu/g to 90 emu/g. Furthermore, it is preferable to employ high magnetization materials such as iron powder of 100 emu/g or more or magnetite of 75 emu/g to 120 emu/g for the purpose of securing image density. Moreover, it is preferable to employ low magnetization materials such as copper-zinc (Cu—Zn) of 30 emu/g to 80 emu/g because the impact toward the electrostatic image bearing member having the toner in the form of magnetic brush can be relieved and because it is advantageous for higher image quality. These may be used alone or in combination.

The particle diameter of the core material is preferably 10 μm to 200 μm, more preferably 40 μm to 100 μm, in terms of an average particle diameter (weight average particle diameter (D50). When the average particle diameter (volume average particle diameter (D50)) is less than 10 μm, the amount of fine powder increases in the carrier, and magnetization per particle decreases and carrier scattering may occur. When it is greater than 200 μm, the specific surface area of the carrier decreases and thus toner scattering may occur. As a result, in the case of printing a full-color image having many solid portions, especially the reproduction of the solid portions may decrease.

The material of the resin layer is not particularly limited and may be appropriately selected from known resins depending on the intended purpose. Examples thereof include amino resins, polyvinyl resins, polystyrene resins, halogenated olefin resins, polyester resins, polycarbonate resins, polycarbonate resins, polyethylene resins, polyvinylfluoride resins, polyvinylidenefluoride resins, polytrifluoroethylene resins, polyhexafluoropropylene resins, copolymers of vinylidene fluoride and acryl monomers, fluoroterpolymers such as terpolymers of tetrafluoroethylene, vinylidenefluoride and non-fluoride monomers (fluorinated three-component (multi-component) copolymers) and silicone resins. These may be used alone or in combination.

The silicone resin is not particularly limited and may be appropriately selected depending on the intended purpose. Examples thereof include straight silicone resins formed of organosiloxane bonds.

The straight silicone resin is not particularly limited and may be appropriately selected depending on the intended purpose. Examples thereof include silicone resins modified with alkyd resins, polyester resins, epoxy resins, acryl resins and urethane resins.

Note that, the silicone resin may be used alone, or may be used in combination with, for example, a crosslinkable component and a charge amount-adjusting ingredient.

If necessary, the resin layer may further contain, for example, electroconductive powder. The electroconductive powder is not particularly limited and may be appropriately selected depending on the intended purpose. Examples thereof include metal powder, carbon black, titanium oxide, tin oxide and zinc oxide.

The average particle diameter of the electroconductive powder is not particularly limited and may be appropriately selected depending on the intended purpose, but is preferably 1 μm or less. When the average particle diameter thereof is more than 1 μm, electrical resistance may be difficult to control.

The resin layer may be formed, for example, as follows. Specifically, the above silicone resin and other materials are dissolved in a solvent to prepare a coating solution, and then the thus-prepared coating solution is uniformly coated on the surface of the core material with a known coating method, followed by drying and then baking.

Examples of the coating method include immersion methods, spray methods, roller coat methods, bar coat methods, kneader coat methods and curtain coat methods.

The solvent is not particularly limited and may be appropriately selected depending on the intended purpose. Examples thereof include toluene, xylene, methyl ethyl ketone, methyl isobutyl ketone, cellosolve and butyl acetate.

A method for the baking is not particularly limited, and may an externally heating method or an internally heating method. Examples thereof include methods employing a fixed-type electric furnace, a fluid-type electric furnace, a rotary electric furnace or a burner furnace; and methods employing microwave radiation.

The mass of the resin layer in the carrier is not particularly limited, and may an externally heating method or an internally heating method, but is preferably 0.01% by mass to 5.0% by mass. When the mass thereof is less than 0.01% by mass, a uniform resin layer may not be formed on the surface of the core material. Whereas when it is more than 5.0% by mass, the formed resin layer becomes so thick that adhesion between carrier particles occurs, potentially resulting in failure to form uniform carrier particles.

When the developer is the two-component developer, the amount of the carrier in the two-component developer is not particularly limited and may be appropriately selected depending on the intended purpose, but is preferably 90% by mass to 98% by mass, more preferably 93% by mass to 97% by mass.

Regarding a mixing ratio between the toner and the carrier in the two-component developer, generally, the amount of the toner is preferably 1 part by mass to 10.0 parts by mass per 100 parts by mass of the carrier.

### (Image Forming Apparatus)

An image forming apparatus of the present invention includes: a latent electrostatic image bearing member (hereinafter may be referred to as “photoconductor”); a charging unit configured to charge a surface of the latent electrostatic image bearing member; an exposing unit configured to expose the charged surface of the latent electrostatic image bearing member to light to form a latent electrostatic image; a developing unit configured to develop the latent electrostatic image with the toner to form a visible image; a transfer unit configured to transfer the visible image onto a recording medium; and a fixing unit configured to fix the visible image transferred on the recording medium.

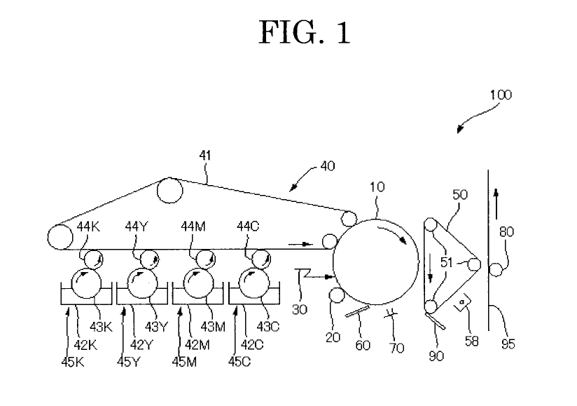

An aspect of a method for forming an image using the image forming apparatus of the present invention will next be described with reference to FIG. 1. An image forming apparatus 100 shown in FIG. 1 is equipped with a latent electrostatic image bearing member 10 as the latent electrostatic image bearing member, a charge roller 20 as the charging unit, an exposure device 30 as the exposing unit, a developing device 40 as the developing unit, an intermediate transfer member 50, a cleaning device 60 as the cleaning means having a cleaning blade, and a charge-eliminating lamp 70 as a charge-eliminating unit.

The intermediate transfer member 50 is an endless belt being extended over the three rollers 51 placed inside the belt and designed to be moveable in the arrow direction. A part of three rollers 51 function as a transfer bias roller capable of applying a specified transfer bias (primary transfer bias), to the intermediate transfer member 50. The cleaning blade 90 for intermediate transfer member is placed near the intermediate transfer member 50, and a transfer roller 80, as a transferring unit capable of applying a transfer bias for transferring (secondary transferring) a developed image (toner image) onto a recording paper 95, is placed near the intermediate transfer member 50 to face the intermediate transfer member 50. In the surrounding area of the intermediate transfer member 50, a corona charger 58 for supplying an electrical charge to the toner image on the intermediate transfer belt 50 is placed between contact area of the photoconductor 10 and the intermediate transfer member 50, and contact area of the intermediate transfer member 50 and the recording paper 95 in the rotational direction of the intermediate transfer member 50.

The developing device 40 is constructed with a developing belt 41 as a developer carrier, a black developing device 45K, a yellow developing device 45Y, a magenta developing device 45M and a cyan developing device 45C disposed together in the surrounding area of the developing belt 41. The black developing device 45K is equipped with a developer container 42K, a developer feeding roller 43K, and a developing roller 44K. The yellow developing device 45Y is equipped with a developer container 42Y, a developer feeding roller 43Y, and a developing roller 44Y. The magenta developing device 45M is equipped with a developer container 42M, a developer feeding roller 43M, and a developing roller 44M. The cyan developing device 45C is equipped with a developer container 42C, a developer feeding roller 43C, and a developing roller 44C. The developing belt 41 is an endless belt and is extended between several belt rollers as rotatable, and a part of the developing belt 41 is in contact with the latent electrostatic image bearing member 10.

For example, the charge roller 20 charges the latent electrostatic image bearing member 10 evenly in the image forming apparatus 100 shown in FIG. 1. The exposure device 30 exposes imagewise on the latent electrostatic image bearing member 10 and forms a latent electrostatic image. The latent electrostatic image formed on the latent electrostatic image bearing member 10 is then developed with the toner fed from the developing device 40 to form a toner image. The toner image is then transferred (primary transferred) onto the intermediate transfer member 50 by a voltage applied from the roller 51 and is transferred (secondary transferred) onto the recording paper 95. As a result, a transfer image is formed on the recording paper 95. The residual toner on the latent electrostatic image bearing member 10 is removed by the cleaning device 60 and the charge built up over the latent electrostatic image bearing member 10 is temporarily removed by the charge-eliminating lamp 70.

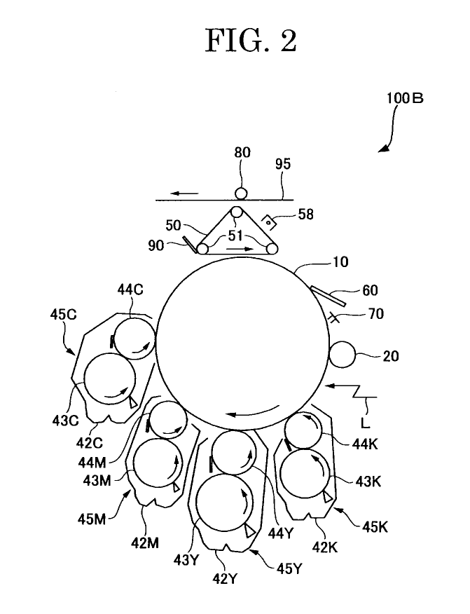

Another example of an image forming apparatus in the present invention is shown in FIG. 2. An image forming apparatus 100B as shown in FIG. 2 has the same construction as an image forming apparatus 100 shown in FIG. 1 except that the developing belt 41 is not equipped and the black developing device 45K, the yellow developing device 45Y, the magenta developing device 45M and the cyan developing device 45C are placed in the surrounding area directly facing the latent electrostatic image bearing member 10.

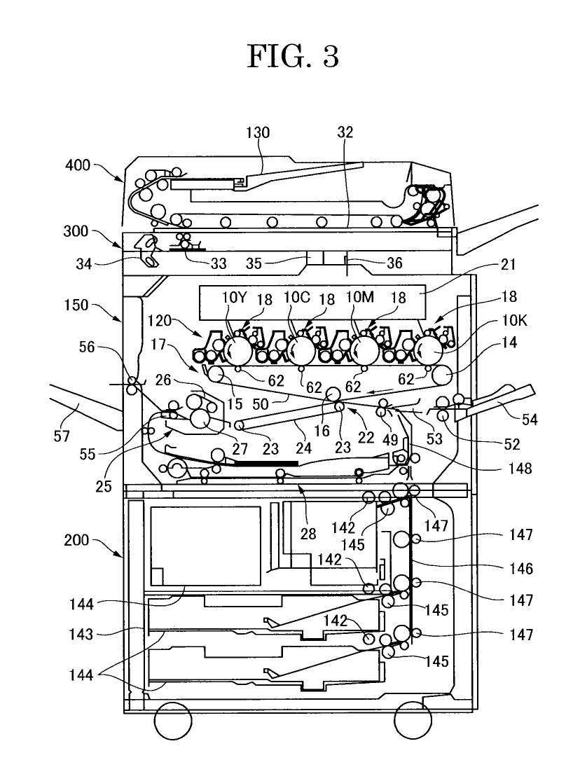

An image forming apparatus illustrated in FIG. 3 includes a copying device main body 150, a paper feeding table 200, a scanner 300 and an automatic document feeder (ADF) 400.

The copying device main body 150 is provided at its center portion with an endless belt-shaped intermediate transferring member 50. In FIG. 3, the intermediate transfer member 50 can be clockwise rotated by supporting rollers 14, 15 and 16. A cleaning device 17 for removing toner particles remaining on the intermediate transfer member 50 is disposed in the vicinity of the supporting roller 15. Around the intermediate transfer member 50 tightly stretched by supporting rollers 14 and 15 is provided a tandem developing device 120 in which four image forming units 18 for yellow toner, cyan toner, magenta toner and black toner are arranged in a row along a moving direction of the intermediate transfer member. An exposing device 21 is provided in the vicinity of the tandem developing device 120. A secondary transfer device 22 is provided on the intermediate transfer member 50 on the side opposite to the side where the tandem developing device 120 is disposed. The secondary transfer device 22 includes an endless belt-shaped secondary transfer belt 24 and a pair of supporting rollers 23 tightly stretching the belt. A recording paper fed on the secondary transfer belt 24 can come into contact with the intermediate transfer member 50. A fixing device 25 is provided in the vicinity of the secondary transfer device 22. The fixing device 25 includes an endless fixing belt 26 and a press roller 27 provided so as to be pressed against the fixing belt.

Notably, in the tandem image forming apparatus, a sheet reversing device 28 for reversing the recording paper when image formation is performed on both sides of the recording paper is disposed in the vicinity of the secondary transfer device 22 and the fixing device 25.

Next will be described formation of a full color image (color copy) using the tandem developing device 120. Firstly, an original document is set on a document table 130 of the automatic document feeder (ADF) 400. Alternatively, the automatic document feeder 400 is opened and then an original document is set on a contact glass 32 of the scanner 300, followed by closing of the automatic document feeder 400.

In the former case, when a starting switch is pressed, the scanner 300 is operated to run a first carriage 33 and a second carriage 34 after the original document has been transferred onto the contact glass 32. In the latter case, when a starting switch (not illustrated) is pressed, the scanner 300 is operated to run a first carriage 33 and a second carriage 34 immediately after the original document has been set on the contact glass 32. At that time, the first carriage 33 irradiates the original document with light from a light source, and then the second carriage 34 reflects, on its mirror, light reflected by the original document. The thus-reflected light is received by a reading sensor 36 through an imaging lens 35 for reading the original document (color image), to thereby form image information corresponding to black, yellow, magenta and cyan.

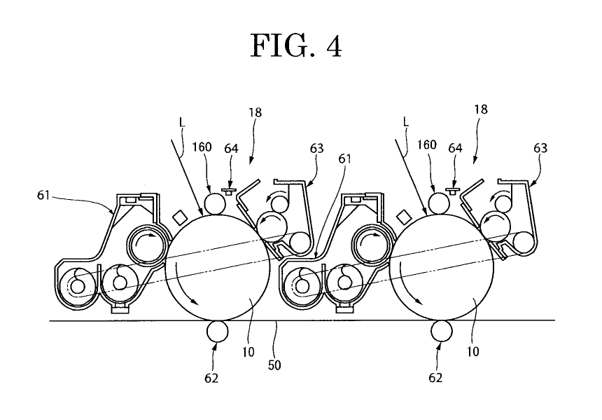

The thus-formed image information corresponding to black, yellow, magenta and cyan is transferred to a corresponding image forming unit 18 (black-, yellow-, magenta- or cyan-image forming unit) in the tandem developing device 120, and then a toner image of each of black, yellow, magenta and cyan is formed with the image forming unit. Specifically, as illustrated in FIG. 4, each of the image forming units 18 (black-, yellow-, magenta- and cyan-image forming units) in the tandem developing device 120 includes a latent electrostatic image bearing member 10 (black-latent electrostatic image bearing member 10K, yellow-latent electrostatic image bearing member 10Y, magenta-latent electrostatic image bearing member 10M or cyan-latent electrostatic image bearing member 10C); a charger 160 for uniformly charging the latent electrostatic image bearing member 10; an exposing device for imagewise exposing the latent electrostatic image bearing member to light (indicated by a symbol L in FIG. 4) based on image information corresponding to black, yellow, magenta and cyan to form thereon a latent electrostatic image corresponding to each of black, yellow, magenta and cyan; a developing device 61 for developing the latent electrostatic image with each color toner (black toner, yellow toner, magenta toner and cyan toner) to form a color toner image; a transfer charger 62 for transferring the color toner image onto the intermediate transfer member 50; a cleaning device 63; and a charge-eliminating device 64. Each image forming unit 18 can form each monochromatic image (black, yellow, magenta or cyan image) based on image information corresponding to each color. The thus-formed black, yellow, magenta and cyan images—a black image formed on the black-latent electrostatic image bearing member 10K, a yellow image formed on the yellow-latent electrostatic image bearing member 10Y, a magenta image formed on the magenta-latent electrostatic image bearing member 10M, and a cyan image formed on the cyan-latent electrostatic image bearing member 10C—are sequentially transferred (primarily transferred) onto the intermediate transfer member 50 driven by the supporting rollers 14, 15 and 16 so as to be rotated. Then, the black, yellow, magenta and cyan images are superposed on the intermediate transfer member 50 to form a composite color image (transferred color image).

In the paper feeding table 200, one of paper feeding rollers 142 is selectively rotated to feed sheets (recording paper) from one of vertically stacked paper feeding cassettes 144 housed in a paper bank 143. The thus-fed sheets are separated one another by a separating roller 145. The thus-separated sheet is fed through a paper feeding path 146, then fed through a paper feeding path 148 in a copying device main body 150 by a transfer roller 147, and stopped at a resist roller 49. Alternatively, paper feeding rollers 142 are rotated to feed sheets (recording paper) placed on a manual-feeding tray 54. The thus-fed sheets are separated one another by a separating roller 52. The thus-separated sheet is fed through a manual paper-feeding path 53 and then stopped at a resist roller 49 similar to the above. Notably, the resist roller 49 is generally connected to the ground in use. Alternatively, it may be used with being applied by a bias for removing paper dust from the sheet. The resist roller 49 is rotated to feed a sheet (recording paper) between the intermediate transfer member 50 and the secondary transfer device 22 so that the composite color image (transferred color image) formed on the intermediate transfer member 50 is transferred (secondarily transferred) onto the sheet (recording paper), whereby a color image is formed on the sheet (recording paper). Notably, toner particles remaining on the intermediate transfer member 50 after image transfer is removed by a cleaning device 17 for cleaning the intermediate transfer member.

The sheet (recording paper) having a color image is fed by the secondary transfer device 22 to a fixing device 25. The fixing device 25 fixes the composite color image (transferred color image) on the sheet (recording paper) through application of heat and pressure. Subsequently, the sheet (recording paper) is discharged from a discharge roller 56 by a switching claw 55 and then stacked on a discharge tray 57. Alternatively, the sheet (recording paper) is reversed with the sheet reversing device 28 by a switching claw 55 and conveyed again to a position where transfer is performed. Thereafter, an image is formed on the back surface thereof, and then the thus-obtained sheet is discharged from a discharge roller 56 and stacked on a discharge tray 57.

### EXAMPLES

The present invention will next be described by way of Examples and Comparative Examples in more detail. However, the present invention should not be construed as being limited to Examples.

Unless otherwise specified, the units “part(s)” and “%” in Examples mean “part(s) by mass” and “% by mass,” respectively. First, description will be given to analysis and evaluation methods of toners obtained in Examples and Comparative Examples.

Hereinafter, evaluation was performed when the toner of the present invention was used as a one-component developer. However, the toner of the present invention may be used as a two-component developer also together with a suitable carrier through suitable external additive treatment.

### <Average Particle Diameter>

First, 0.1 mL to 5 mL of a surfactant (AUTOACE, product of Micro Inc.) serving as a disperser was added to 100 mL to 150 mL of an aqueous electrolyte solution. Subsequently, 2 mg to 20 mg of a measurement sample was added to the resultant solution. The electrolyte solution where the measurement sample had been suspended was dispersed with an ultrasonic wave disperser for about 1 min to about 3 min. The thus-obtained dispersion liquid was analyzed using COULTER COUNTER (TA-II, product of Coulter Inc.) with an aperture being 100 μm to thereby measure the number and volume of toner particles. Then, the volume particle size distribution and number particle size distribution were calculated from the obtained values. The obtained distributions were used to calculate the volume average particle diameter (D4) and the number average particle diameter (D1) of the toner.

In the above measurement, 13 channels were used: 2.00 nm (inclusive) to 2.52 μm (exclusive); 2.52 μm (inclusive) to 3.17 μm (exclusive); 3.17 μm (inclusive) to 4.00 μm (exclusive); 4.00 μm (inclusive) to 5.04 μm (exclusive); 5.04 μm (inclusive) to 6.35 μm (exclusive); 6.35 μm (inclusive) to 8.00 μm (exclusive); 8.00 μm (inclusive) to 10.08 μm (exclusive); 10.08 μm (inclusive) to 12.70 μm (exclusive); 12.70 μm (inclusive) to 16.00 μm (exclusive); 16.00 μm (inclusive) to 20.20 μm (exclusive); 20.20 μm (inclusive) to 25.40 μm (exclusive); 25.40 μm (inclusive) to 32.00 μm (exclusive); and 32.00 μm (inclusive) to 40.30 μm (exclusive); i.e., particles having a particle diameter of 2.00 μm (inclusive) to 40.30 μm (exclusive) were subjected to the measurement.

### <Average Circularity>

The average circularity was measured by performing measurement using a flow-type particle image analyzer (FPIA-2000, product of Sysmex Co.) and analyzing the measurements by analysis software FPIA-2000 Data Processing Program for FPIA version 00-10.

Specifically, 0.1 mL to 0.5 mL of a 10% by mass surfactant (alkylbenzene sulfonate, Neogen SC-A, product of Daiichi Kogyo Seiyaku Co.) was added to a 100 mL-glass beaker, and 0.1 g to 0.5 g of each toner was added thereto, followed by stirring with a microspartel. Subsequently, 80 mL of ion-exchange water was added to the beaker, and the obtained dispersion liquid was dispersed for 1 min using an ultrasonic wave disperser (product of STM Co., UH-50) at 20 kHz and 50 W/10 cm³. Furthermore, the resultant dispersion liquid was further dispersed for a total of 5 min so that the concentration of the particles in the measurement sample was 4,000 particles/10⁻³ cm³ to 8,000 particles/10⁻³ cm³, which had a circle-equivalent diameter of 0.60 μm or greater but smaller than 159.21 μm. The thus-prepared sample dispersion liquid was used to measure the particle size distribution and shape of the particles having a circle-equivalent diameter of 0.60 μm or greater but smaller than 159.21 μm.

The sample dispersion liquid was caused to pass through a flow channel (extending in a flowing direction) of a flat transparent flow cell (thickness: about 200 μm). In order to form an optical path which passes through and intersects with the flow cell in the thickness direction, a stroboscope and a CCD camera were mounted on the flow cell so as to be located at the opposite side to each other. With the sample dispersion liquid flowing, strobe light was applied thereto at an interval of 1/30 sec so as to obtain an image of each particle flowing in the flow cell. As a result, each particle was photographed as a two-dimensional image having a certain area parallel to the flow cell. Based on the area of each particle in the two-dimensional image, the diameter of a circle having the same area was calculated as the circle-equivalent diameter. With the above-described method, the circle-equivalent diameters of 1,200 or more particles can be measured for about 1 min. The number of the particles based on the distribution of the circle-equivalent diameters can be measured. Similarly, the rate (number %) of particles with a predetermined circle-equivalent diameter was measured. The results (frequency % and cumulative %) could be obtained by dividing a range of 0.06 μm to 400 μm into 226 channels (dividing 1 octave into 30 channels). The actual measurement was performed on particles having a circle-equivalent diameter of 0.60 μm or greater but smaller than 159.21 μm.

### <Volume Average Particle Diameter of Resin Particles>

The volume average particle diameter of resin particles was measured by a nano-track particle size distribution analyzer (UPA-EX150, product of Nikkiso Co., Ltd., (a dynamic light scattering method/a laser Doppler method)).

Specifically, a dispersion liquid containing resin particles dispersed therein was adjusted to be within a measurable concentration range before measurement. At the same time, only the dispersion solvent of the dispersion liquid was measured for background.

### <Storage Modulus G′>

The dynamic viscoelastic properties of the resin and the toner (storage modulus G′) were measured using a dynamic viscoelasticity measuring apparatus (ARES, product of TA Instruments, Inc.)). It was measured under a frequency of 1 Hz.

A sample was formed into pellets having a diameter of 8 mm and a thickness of 1 mm to 2 mm, fixed on a parallel plate having a diameter of 8 mm, which was then stabilized at 40° C., and heated to 200° C. at a heating rate of 2.0° C./min with a frequency of 1 Hz (6.28 rad/s) and a strain amount of 0.1% (strain amount control mode), and a measurement was taken.

### <Molecular Weight>

The molecular weight of the resin used such as the polyester resin or the vinyl resin was measured through GPC (gel permeation chromatography) under the following conditions.

Apparatus: HLC-8220GPC (product of Tosoh Corporation)

### Column: TSKgel SuperHZM-M×3

### Temperature: 40° C.

Solvent: THF (tetrahydrofuran)
Flow rate: 0.35 mL/min
Sample injected: 0.01 mL of a sample having a concentration of 0.05% to 0.6%

From the molecular weight distribution of the toner resin measured under the above conditions, the weight average molecular weight (Mw) of the resin was calculated using a molecular weight calibration curve obtained from monodispersed polystyrene standard samples. The monodispersed polystyrene standard samples used were the following ten samples: 5.80×10², 2.93×10³, 1.09×10⁴, 2.85×10⁴, 5.95×10⁴, 1.48×10⁵, 3.20×10⁵, 2.56×10⁶, 8.42×10⁵ and 7.50×10⁶.

### <Glass Transition Temperature and Endothermic Amount>

The glass transition temperature of the polyester resin used was measured using a differential scanning calorimeter (DSC-6220R, product of Seiko Instruments Inc.) in the following manner: heat a sample from room temperature to 150° C. at a heating rate of 10° C./min; leave the sample at 150° C. for 10 min; cool down the sample to room temperature; leave the sample at room temperature for 10 min; heat the sample again to 150° C. at a heating rate of 10° C./min; and determining the glass transition temperature and the endothermic amount from a part of the curve corresponding to ½ the height between the baseline at a temperature equal to or lower than the glass transition temperature and the baseline at a temperature equal to or higher than the glass transition temperature.

The endothermic amount and the melting point of the releasing agent, the crystalline resin and the toner were measured in the same manner. The endothermic amount was determined by calculating the peak area of the endothermic peak measured. Although some releasing agents involve not only the heat of fusion but also the heat of transition due to phase transition in a solid phase, the total amount of the heat was defined as the endothermic amount in the present invention. Also, a temperature at the minimal value of the endothermic peak was defined as the melting point.

Note that, the melting point (Tin) of the toner in the present invention was measured prior to the addition of the external additives.

The amount of the crystalline resin in the toner was measured in the following manner. Specifically, a differential scanning calorimeter (Q200 temperature modified DSC, product of TA Instruments, Inc.) was used to heat about 5 mg of the toner from −20° C. to 150° C. at an average temperature raising rate of 1° C./min and a temperature amplitude of 0.5° C./60 sec, to thereby measure the heat of fusion of the toner. Based on a calibration curve prepared or the heat amount of the fusion of the crystalline resin alone being regarded as 100%, the heat amount of the fusion of the crystalline resin of the total heat flow was converted to the amount of the crystalline resin in the toner.

### (Evaluation Method)<

### Chargeability (Background Smear)>

The toner was placed in the Bk cartridge of printer IPSIO SP C220 (product of Ricoh Company, Ltd.) and was caused to print, on one blank paper sheet, a 5% chart of test chart No. 8 published by The Imaging Society of Japan. After that, the surfaces of the blank paper sheet and the photoconductor were visually observed.

### (Evaluation Criteria)

A: The toner was deposited neither on the blank paper sheet nor on the photoconductor.
B: The toner was not deposited on the blank paper sheet, but when the photoconductor was observed obliquely, the toner was slightly deposited on the photoconductor.
C: When the blank paper sheet was observed obliquely, the toner was slightly deposited on the blank paper sheet.
D: The toner was clearly deposited on the blank paper sheet.

### <Fixing Property (Low-Temperature Stability)>

The toner was placed in a modified product of printer IPSIO SP C220 (product of Ricoh Company, Ltd.), and was caused to print a 50 mm×50 mm prefixed solid image on 19 sheets of Type 6200Y paper (product of Ricoh Company, Ltd.) with the toner deposition amount being adjusted to 10 g/m².

Next, the thus-formed sheets each having the prefixed solid image were caused to pass through and fixed by a modified fixing unit at a system speed of 280 mm/sec, with the fixing temperature being increased from 120° C. to 200° C. in increments of 5° C. The sheets were folded so that the fixed images thereon were folded internally, and then opened again. The lowest temperature at which the fold line remained after gently rubbing with an eraser was defined as a lower-limit fixing temperature.

(Evaluation criteria)
A: Lower-limit fixing temperature<100° C.
B: 100° C.≦Lower-limit fixing temperature<110° C.
C: 110° C.≦Lower-limit fixing temperature<120° C.
D: 120° C.≦Lower-limit fixing temperature

### <Heat Resistance Storageability>

The toner sample (25 g) was charged into a 50 mL-glass container, which was then left to stand in a thermostat bath of 55° C. for 24 hours, followed by cooling to 24° C. The thus-treated toner was measured for penetration degree according to the penetration test (JIS K2235-1991) and evaluated for heat resistance storageability according to the following criteria. Notably, the greater penetration degree means more excellent heat resistance storageability. A toner having a penetration degree less than 10 mm is highly likely to cause problems in use.

### [Evaluation Criteria]

A: 20 mm≦Penetration degree
B: 15 mm≦Penetration degree<20 mm
C: 10 mm≦Penetration degree<15 mm
D: Penetration degree<10 mm

### <Transfer Rate>

The transfer rate was measured in the following manner. After the entire image had been developed in black, the operation of a printer (IPSIO SP C220, product of Ricoh Company, Ltd.) was stopped in the course of transfer, and the toner on untransferred and transferred portions on the photoconductor was sampled with adhesive paper sheets each having a known mass and a constant area, followed by weighing. The transfer rate was determined by: [(the mass of the toner on the untransferred portion—the mass of the toner on the transferred portion)/the mass of the toner on the untransferred portion]×100.

### (Evaluation Criteria)

A: 90%≦Transfer rate
B: 80%≦Transfer rate<90%
C: Transfer rate<80%

### <Cleanability>

The cleanability was evaluated in the following manner. After the photoconductor had formed 1,000 sheets each having an image area rate of 95% using printer IPSIO SP C220 (product of Ricoh Company, Ltd.) and undergone a cleaning step, the toner remaining on the photoconductor was transferred onto a blank paper sheet with a piece of scotch tape (product of Sumitomo 3M Ltd.). The blank paper sheet was measured for density with a MACBETH reflective densitometer model RD514. Separately, a blank paper sheet having only a piece of scotch tape without the toner remaining was measured for density similarly. Then, the difference between the obtained value and the blank value was calculated, and the cleanability was evaluated the following criteria.

### <Evaluation Criteria>

### A: Difference<0.005

### B: 0.005≦Difference<0.010

### C: 0.010≦Difference<0.020

### D: 0.020≦Difference

Next, preparation methods for toner raw materials used in Examples will be described.

### Production Example 1

### <Production of Crystalline Polyester Resin C-1>

A reaction container equipped with a condenser, a stirrer and a nitrogen-introducing tube was charged with 353 parts of 1,10-decanediol, 289 parts of adipic acid and 0.8 parts of dibutyltin oxide, and the mixture was allowed to react under normal pressure at 180° C. for 6 hours. Next, the reaction mixture was allowed to react at a reduced pressure of 10 mmHg to 15 mmHg for 4 hours, to thereby synthesize [crystalline polyester resin C-1]. The obtained [crystalline polyester resin C-1] was found to have a number average molecular weight of 14,000, a weight average molecular weight of 33,000 and a melting point of 65° C., and the maximal endothermic amount thereof was observed at the melting point.

### Production Example 2

### <Production of Crystalline Polyester Resin C-2>

A reaction container equipped with a condenser, a stirrer and a nitrogen-introducing tube was charged with 160 parts of 1,9-nonanediol, 208 parts of 1,10-dodecanedioic acid, 5.92 parts of dimethyl isophthalate-5-sodium sulfonate, 16.7 parts of 5-t-butylisophthalic acid and 0.4 parts of dibutyltin oxide, and the mixture was allowed to react under normal pressure at 180° C. for 6.5 hours. Next, the reaction mixture was allowed to react at 220° C. and a reduced pressure of 10 mmHg to 15 mmHg for 4 hours, to thereby synthesize [crystalline polyester resin C-2]. The obtained [crystalline polyester resin C-2] was found to have a number average molecular weight of 4,200, a weight average molecular weight of 15,000 and a melting point of 72° C., and the maximal endothermic amount thereof was observed at the melting point.

### Production Example 3

### <Production of Crystalline Polyester Resin C-3>

A reaction container equipped with a condenser, a stirrer and a nitrogen-introducing tube was charged with 124 parts of ethylene glycol, 139 parts of adipic acid, 2.96 parts of dimethyl isophthalate-5-sodium sulfonate, 7.78 parts of 5-t-butylisophthalic acid and 0.4 parts of dibutyltin oxide, and the mixture was allowed to react under normal pressure at 180° C. for 5 hours. After that, extra ethylene glycol was removed through distillation under reduced pressure, and the reaction mixture was allowed to react at 220° C. and a reduced pressure of 10 mmHg to 15 mmHg for 2.5 hours, to thereby synthesize [crystalline polyester resin C-3]. The obtained [crystalline polyester resin C-3] was found to have a number average molecular weight of 3,400, a weight average molecular weight of 10,000 and a melting point of 47° C., and the maximal endothermic amount thereof was observed at the melting point.

### Production Example 4

### <Production of Crystalline Polyester Resin C-4>

A reaction container equipped with a condenser, a stirrer and a nitrogen-introducing tube was charged with 353 parts of 1,10-decanediol, 289 parts of adipic acid and 0.8 parts of dibutyltin oxide, and the mixture was allowed to react under normal pressure at 180° C. for 8 hours. Next, the reaction mixture was allowed to react at a reduced pressure of 10 mmHg to 15 mmHg for 6 hours, to thereby synthesize [crystalline polyester resin C-4]. The obtained [crystalline polyester resin C-4] was found to have a number average molecular weight of 18,000, a weight average molecular weight of 53,000 and a melting point of 67° C., and the maximal endothermic amount thereof was observed at the melting point.

### Production Example 5

### <Production of Crystalline Polyester Resin C-5>

A reaction container equipped with a condenser, a stirrer and a nitrogen-introducing tube was charged with 174 parts of 1,10-decanediol, 289 parts of adipic acid and 0.4 parts of dibutyltin oxide, and the mixture was allowed to react under normal pressure at 180° C. for 5 hours. Next, the reaction mixture was allowed to react at a reduced pressure of 10 mmHg to 15 mmHg for 2 hours, to thereby synthesize [crystalline polyester resin C-5]. The obtained [crystalline polyester resin C-5] was found to have a number average molecular weight of 3,600, a weight average molecular weight of 12,000 and a melting point of 60° C., and the maximal endothermic amount thereof was observed at the melting point.

### Production Example 6

### <Production of Crystalline Polyurea Resin E-1>

A reaction vessel equipped with a condenser, a stirrer and a nitrogen-introducing tube was charged with 79 parts (0.90 mol) of 1,4-butanediamine, 116 parts (1.00 mol) of 1,6-hexanediamine and 600 parts of methyl ethyl ketone (MEK), followed by stirring. Then, 475 parts (1.90 mol) of 4,4′-diphenylmethane diisocyanate (MDI) was added to the resultant mixture, which was allowed to react at 60° C. for 3 hours under nitrogen flow. Next, the MEK was removed under reduced pressure to obtain [crystalline polyurea resin E-1]. The obtained [crystalline polyurea resin E-1] was found to have a Mw of 39,000 and a melting point of 62° C., and the maximal endothermic amount thereof was observed at the melting point.

### Production Example 7

### <Production of Urethane-Modified Crystalline Polyester Resin F-1>

A reaction vessel equipped with a condenser, a stirrer and a nitrogen-introducing tube was charged with 202 parts (1.00 mol) of sebacic acid, 189 parts (1.60 mol) of 1,6-hexanediol and 0.5 parts of dibutyltin oxide serving as a condensation catalyst, and the mixture was allowed to react for 8 hours at 180° C. under nitrogen flow while removing water formed. Next, with the reaction temperature gradually increased to 220° C., the reaction mixture was allowed to react for 4 hours under nitrogen flow while removing water formed and 1,6-hexanediol. The reaction was allowed to proceed further at a reduced pressure of 5 mmHg to 20 mmHg until the Mw of the product reached about 7,000, to thereby obtain [crystalline polyester resins F′-1]. The obtained [crystalline polyester resin F′-1] was found to have a Mw of 7,000.

Subsequently, the [crystalline polyester resin F′-1] was transferred to a reaction vessel equipped with a condenser, a stirrer and a nitrogen-introducing tube, and 300 parts of ethyl acetate and 38 parts (0.15 mol) of 4,4′-diphenylmethane diisocyanate (MDI) were added to the reaction vessel, where the resultant mixture was allowed to react at 80° C. for 5 hours under nitrogen flow. Then, the ethyl acetate was removed under reduced pressure to obtain [urethane-modified crystalline polyester resin F-1]. The obtained [urethane-modified crystalline polyester resin F-1] was found to have a Mw of 15,000 and a melting point of 65° C., and the maximal endothermic amount thereof was observed at the melting point.

### Production Example 8

### <Production of Crystalline Resin Precursor G-1>

A reaction vessel equipped with a condenser, a stirrer and a nitrogen-introducing tube was charged with 202 parts (1.00 mol) of sebacic acid, 122 parts (1.03 mol) of 1,6-hexanediol and 0.5 parts of titaniumdihydroxybis(triethanolaminate) serving as a condensation catalyst, and the mixture was allowed to react for 8 hours at 180° C. under nitrogen flow while removing water formed. Next, with the reaction temperature gradually increased to 220° C., the reaction mixture was allowed to react for 4 hours under nitrogen flow while removing water formed and 1,6-hexanediol. The reaction was allowed to proceed further at a reduced pressure of 5 mmHg to 20 mmHg until the Mw of the product reached about 25,000, to thereby obtain [crystalline polyester resins G′-1].

Subsequently, the [crystalline polyester resin G′-1] was transferred to a reaction vessel equipped with a condenser, a stirrer and a nitrogen-introducing tube, and 300 parts of ethyl acetate and 27 parts (0.16 mol) of hexamethylene diisocyanate (HDI) were added to the reaction vessel, where the resultant mixture was allowed to react at 80° C. for 5 hours under nitrogen flow, to thereby obtain a 50% by mass ethyl acetate solution of [crystalline resin precursor G-1] having an isocyanate group at an end thereof.

Then, 10 parts of the obtained 50% by mass ethyl acetate solution of [crystalline resin precursor G-1] was mixed with 10 parts of tetrahydrofuran (THF), and 1 part of dibutylamine was added to the mixture, followed by stirring for 2 hours. As a result of GPC using the obtained solution as a sample, the [crystalline resin precursor G-1] was found to have a Mw of 53,000. Also, as a result of DSC using as a sample obtained by removing the solvent from the solution, the [crystalline resin precursor G-1] was found to have a melting point of 57° C., and the maximal endothermic amount thereof was observed at the melting point.

### Production Example 9

### <Production Non-Crystalline Polyester Resin A-1>

A reaction vessel equipped with a condenser, a stirrer and a nitrogen-introducing tube was charged with 229 parts of bisphenol A ethylene oxide 2 mol adduct, 529 parts of bisphenol A propylene oxide 3 mol adduct, 208 parts of terephthalic acid, 46 parts of adipic acid and 2 parts of dibutyltin oxide, and the mixture was allowed to react under normal pressure at 230° C. for 8 hours. Next, the reaction mixture was allowed to react for 5 hours under a reduced pressure of 10 mmHg to 15 mmHg, and 44 parts of trimellitic anhydride was added to the reaction vessel, followed by reaction under normal pressure at 180° C. for 2 hours, to thereby synthesize [non-crystalline polyester resin A-1]. The obtained [non-crystalline polyester resin A-1] was found to have a number average molecular weight of 2,500, a weight average molecular weight of 6,700, a glass transition temperature of 43° C. and an acid value of 25 mgKOH/g.

### Production Example 10

### <Production of Colorant Dispersion Liquid>

A beaker was charged with 20 parts of copper phthalocyanine, 4 parts of a colorant disperser (Solsperse 28000, product of Avecia Co. Ltd.) and 76 parts of ethyl acetate, followed by uniformly dispersing with stirring. Then, the copper phthalocyanine was finely dispersed with a beads mill to thereby obtain [colorant dispersion liquid 1]. The [colorant dispersion liquid 1] was found to have a volume average particle diameter of 0.3 μm when measured using a particle size analyzer (LA-920, product of HORIBA, Co. Ltd.).

### Production Example 11

### <Production of Releasing Agent Disperser>

An autoclave reaction vessel equipped with a thermometer and a stirrer was changed with 454 parts of xylene and 150 parts of a low-molecular-weight polyethylene (SUNWAX LEL-400, product of Sanyo Chemical Industries, Ltd. (softening point: 128° C.)). After the vessel had been purged with nitrogen, the mixture was heated to 170° C. and thoroughly dissolved. Then, a solution containing 595 parts of styrene, 255 parts of methyl methacrylate, 34 parts of di-t-butylperoxyhexahydro terephthalate and 119 parts of xylene was added dropwise to the mixture at 170° C. for 3 hours to perform polymerization, and the resultant mixture was kept at the same temperature for 30 min. Next, the solvent was removed to obtain [releasing agent disperser 1]. The [releasing agent disperser 1] was found to have a Mn of 1,872, a Mw of 5,194 and a Tg of 56.9° C.

### Production Example 12

### <Production of Wax Dispersion Liquid>

A reaction container equipped with a thermometer and a stirrer was changed with 10 parts of paraffin wax (melting point: 73° C.), 1 part of the [releasing agent disperser 1] and 33 parts of ethyl acetate. The mixture was heated to 78° C. and thoroughly dissolved, and cooled for 1 hour to 30° C. to precipitate the wax as fine particles. The thus-treated mixture was further pulverized in a wet process with ULTRAVISCOMILL from Aimex Co., Ltd.) to thereby obtain [wax dispersion liquid 1].

### Example 1

### <Production of Resin Solution>

A reaction container equipped with a thermometer and a stirrer was charged with 100 parts of the [crystalline polyester resin C-1] and 100 parts of ethyl acetate. The mixture was heated to 50° C. and stirred to have a homogeneous phase, to thereby obtain [resin solution 1].

### <Oil Phase Preparation Step>

A beaker was charged with 60 parts of the [resin solution 1], 27 parts of the [wax dispersion liquid 1], 10 parts of the [colorant dispersion liquid 1] and 1 part of layered inorganic mineral montmorillonite at least one of which was modified with a quaternary ammonium salt having a benzyl group (CLAYTONE APA, product of Southern Clay Products Inc.). The mixture was stirred using TK homomixer at 50° C. and 8,000 rpm, and uniformaly dissolved and dispersed to obtain [toner material liquid 1].

### <Aqueous Phase Preparation Step>

A beaker was charged with 97 parts of ion-exchange water, 6 parts of a 25% aqueous dispersion liquid of organic resin particles for stabilizing dispersion (a copolymer of styrene-butyl acrylate-sodium salt of methacrylic acid ethylene oxide adduct sulfate ester) (OMS-17R, product of Sanyo Chemical Industries, Ltd.), 1 part of sodium carboxylmethylcellulose, a 48.5% aqueous solution of sodium dodecylsulfonate (SDS) (in such an amount that the amount of the SDS was 1.2 parts per 100 parts of the obtained aqueous phase) and sodium chloride in such an amount that the amount of the sodium chloride was 0.6 parts per 100 parts of the obtained aqueous phase, followed by uniformly dissolving, to thereby obtain an aqueous phase.

### <Slurry Preparation Step>

Next, under stirring with the TK homomixer at 50° C. and 10,000 rpm, 75 parts of the [toner material liquid 1] was added to the above-prepared aqueous phase. The resultant mixture was stirred for 2 min to obtain [slurry 1].

### <Desolvation>

A container to which a stirrer and a thermometer had been set was charged with the [slurry 1], followed by desolvating at 30° C. for 8 hours, to thereby obtain [dispersion slurry 1].

### <Washing to Drying>

The [dispersion slurry 1] (100 parts) was filtrated under reduced pressure, and the obtained filtration cake was treated in the following manner.

(1): Ion exchange water (100 parts) was added to the filtration cake, followed by mixing with TK homomixer (at 12,000 rpm for 10 min) and filtrating.
(2): Ion-exchange water (100 parts) was added to the filtration cake obtained in (1). The resultant mixture was mixed with TK homomixer (at 12,000 rpm for 30 min) under application of ultrasonic vibration, followed by filtrating under reduced pressure. This treatment was repeated until the reslurry had an electrical conductivity of 10 μS/cm or lower.
(3): 10% hydrochloric acid was added to the reslurry obtained in (2) so as to have a pH of 4, followed by stirring for 30 min with a three-one motor and filtrating.
(4): Ion-exchange water (100 parts) was added to the filtration cake obtained in (3), followed by mixing with TK homomixer (at 12,000 rpm for 10 min) and filtrating. This treatment was repeated until the reslurry had an electrical conductivity of 10 μS/cm or lower, to thereby obtain [filtration cake 1]. The remaining [dispersion slurry 1] was washed in the same manner as described above, and the washed product was added as the [filtration cake 1].

The [filtration cake 1] was dried with an air-circulation dryer at 45° C. for 48 hours, and then sieved with a mesh having an opening of 75 μm to obtain [toner base 1]. Then, 50 parts of the [toner base 1] was mixed using HENSCHEL MIXER with 1 part of hydrophobic silica having a primary particle diameter of about 30 nm and 0.5 parts of hydrophobic silica having a primary particle diameter of about 10 nm, to thereby obtain [toner 1] of the present invention. The obtained [toner 1] was observed under a scanning electron microscope (SEM).

### Example 2

[Toner 2] was obtained in the same manner as in Example 1 except that the amount of the 48.5% aqueous solution of sodium dodecylsulfonate in the aqueous phase preparation step was changed to such an amount that the amount of the SDS was 0.7 parts per 100 parts of the obtained aqueous phase and the amount of sodium chloride was changed to such an amount that the amount of the sodium chloride was changed to 0.4 parts per 100 parts of the obtained aqueous phase.

### Example 3

[Toner 3] was obtained in the same manner as in Example 1 except that the layered inorganic mineral montmorillonite was not added.

### Example 4

A reaction container equipped with a thermometer and a stirrer was charged with 95 parts of the [crystalline polyester resin C-1], 5 parts of the [non-crystalline polyester resin A-1] and 100 parts of ethyl acetate, and the mixture was heated to 50° C. and stirred to have a homogeneous phase, to thereby obtain [resin solution 4].

[Toner 4] was obtained in the same manner as in Example 1 except that the [resin solution 1] was changed to the thus-obtained [resin solution 4].

### Example 5

A reaction container equipped with a thermometer and a stirrer was charged with 100 parts of the [crystalline polyester resin C-2] and 100 parts of ethyl acetate, and the mixture was heated to 50° C. and stirred to have a homogeneous phase, to thereby obtain [resin solution 5].

[Toner 5] was obtained in the same manner as in Example 1 except that the [resin solution 1] was changed to the thus-obtained [resin solution 5].

### Example 6

A reaction container equipped with a thermometer and a stirrer was charged with 100 parts of the [crystalline polyester resin C-3] and 100 parts of ethyl acetate, and the mixture was heated to 50° C. and stirred to have a homogeneous phase, to thereby obtain [resin solution 6].

[Toner 6] was obtained in the same manner as in Example 1 except that the [resin solution 1] was changed to the thus-obtained [resin solution 6].

### Example 7

A reaction container equipped with a thermometer and a stirrer was charged with 100 parts of the [crystalline polyester resin C-4] and 100 parts of ethyl acetate, and the mixture was heated to 50° C. and stirred to have a homogeneous phase, to thereby obtain [resin solution 7].

[Toner 7] was obtained in the same manner as in Example 1 except that the [resin solution 1] was changed to the thus-obtained [resin solution 7].

### Example 8

A reaction container equipped with a thermometer and a stirrer was charged with 100 parts of the [crystalline polyester resin C-5] and 100 parts of ethyl acetate, and the mixture was heated to 50° C. and stirred to have a homogeneous phase, to thereby obtain [resin solution 8].

[Toner 8] was obtained in the same manner as in Example 1 except that the [resin solution 1] was changed to the thus-obtained [resin solution 8].

### Example 9

[Toner 9] was obtained in the same manner as in Example 1 except that the [crystalline polyester resin C-1] was changed to the [crystalline polyurea resin E-1].

### Example 10

[Toner 10] was obtained in the same manner as in Example 1 except that 100 parts of the [crystalline polyester resin C-1] in the production of the resin solution was changed to 70 parts of the [urethane-modified crystalline polyester resin F-1] and 30 parts of the [crystalline resin precursor G-1].

### Example 11

[Toner 11] was obtained in the same manner as in Example 1 except that sodium chloride in the aqueous phase preparation step was changed to magnesium chloride in such an amount that the amount of the magnesium chloride was 0.01 parts per 100 parts of the obtained aqueous phase.

### Example 12

[Toner 12] was obtained in the same manner as in Example 1 except that sodium dodecysulfonate in the aqueous phase preparation step was changed to sodium dodecylbenzenesulfonate (SDBS).

### Example 13

A reaction container equipped with a thermometer and a stirrer was charged with 80 parts of the [crystalline polyester resin C-1], 20 parts of the [non-crystalline polyester resin A-1] and 100 parts of ethyl acetate, and the mixture was heated to 50° C. and stirred to have a homogeneous phase, to thereby obtain [resin solution 13].

[Toner 13] was obtained in the same manner as in Example 1 except that the [resin solution 1] was changed to the thus-obtained [resin solution 13].

### Comparative Example 1

[Toner 14] was obtained in the same manner as in Example 1 except that the [crystalline polyester resin C-1] was changed to [non-crystalline polyester resin A-1].

### Comparative Example 2

[Toner 15] was obtained in the manner as in Example 1 except that the 48.5% aqueous solution of sodium dodecylsulfonate in the aqueous phase preparation step was changed to a 48.5% aqueous solution of sodium dodecyldiphenylether disulfonate (product of Sanyo Chemical Industries, Ltd., “ELEMINOR MON-7”) (in such an amount that the amount of the sodium dodecyldiphenylether disulfonate was 10 parts per 100 parts of the obtained aqueous phase) and that sodium chloride was not added.

### Comparative Example 3

[Toner 16] was obtained in the same manner as in Example 1 except that the amount of the 48.5% aqueous solution of sodium dodecylsulfonate (SDS) in the aqueous phase preparation step was changed to such an amount that the amount of the SDS was 0.7 parts per 100 parts of the obtained aqueous phase and that sodium chloride was not added.

Table 1 collectively presents properties of each of the toners obtained in Examples and Comparative Examples.

TABLE 1-1

| | | | | Conc. of | | Conc. of |
|---|---|---|---|---|---|---|
| | | | | salt (vs. | | active agent |
| | | | | aqueous | | (vs. aqueous |
| | Binder | Binder | | phase % | Active | phase % |
| | resin 1 | resin 2 | Salt | by mass) | agent | by mass) |
| Ex. 1 | C-1 | — | NaCl | 0.6 | SDS | 1.2 |
| Ex. 2 | C-1 | — | NaCl | 0.4 | SDS | 0.7 |
| Ex. 3 | C-1 | — | NaCl | 0.6 | SDS | 1.2 |
| Ex. 4 | C-1 | A-1 | NaCl | 0.6 | SDS | 1.2 |
| Ex. 5 | C-2 | — | NaCl | 0.6 | SDS | 1.2 |
| Ex. 6 | C-3 | — | NaCl | 0.6 | SDS | 1.2 |
| Ex. 7 | C-4 | — | NaCl | 0.6 | SDS | 1.2 |
| Ex. 8 | C-5 | — | NaCl | 0.6 | SDS | 1.2 |
| Ex. 9 | E-1 | — | NaCl | 0.6 | SDS | 1.2 |
| Ex. 10 | F-1 | G-1 | NaCl | 0.6 | SDS | 1.2 |
| Ex. 11 | C-1 | — | MgCl2 | 0.01 | SDS | 1.2 |
| Ex. 12 | C-1 | — | NaCl | 0.6 | SDBS | 1.2 |
| Ex. 13 | C-1 | A-1 | NaCl | 0.6 | SDS | 1.2 |
| Comp. | — | A-1 | NaCl | 0.6 | SDS | 1.2 |
| Ex. 1 | | | | | | |
| Comp. | C-1 | — | — | 0 | MON-7 | 10 |
| Ex. 2 | | | | | | |
| Comp. | C-1 | — | — | 0 | SDS | 0.7 |
| Ex. 3 | | | | | | |

In Table 1-1, “Active agent” means an organic sulfonic acid salt.

TABLE 1-2

| | | | | | | Rate of | | Avg. volume |
|---|---|---|---|---|---|---|---|---|
| | | | | | | crystaline | Avg. | particle |
| | Toner | Toner | Toner | Toner | Tsh2nd/ | resin | circularity | diameter of |
| | Tm (C. °) | Mw | G′(70) | G′(160) | Tsh1st | (% by mass) | of toner | toner Dv (mm) |
| Ex. 1 | 63 | 30000 | 2.3.E+05 | 3.0.E+03 | 0.99 | 66 | 0.973 | 6.2 |
| Ex. 2 | 62 | 31000 | 2.4.E+05 | 3.1.E+03 | 1.00 | 66 | 0.974 | 6.6 |
| Ex. 3 | 63 | 31000 | 2.6.E+05 | 3.2.E+03 | 0.99 | 66 | 0.979 | 6.3 |
| Ex. 4 | 63 | 29000 | 2.6.E+05 | 5.0.E+03 | 0.96 | 63 | 0.974 | 6.1 |
| Ex. 5 | 73 | 15000 | 1.2.E+05 | 4.0.E+03 | 1.05 | 66 | 0.976 | 6.2 |
| Ex. 6 | 47 | 12000 | 7.0.E+04 | 1.0.E+03 | 1.00 | 66 | 0.976 | 6.2 |
| Ex. 7 | 68 | 47000 | 3.7.E+05 | 4.2.E+03 | 1.01 | 66 | 0.974 | 6.3 |
| Ex. 8 | 61 | 12000 | 9.0.E+04 | 1.0.E+03 | 0.98 | 66 | 0.973 | 6.1 |
| Ex. 9 | 64 | 42000 | 3.0.E+05 | 4.0.E+03 | 0.97 | 66 | 0.972 | 6.6 |
| Ex. 10 | 66 | 45000 | 3.1.E+05 | 4.1.E+03 | 1.00 | 66 | 0.973 | 5.9 |
| Ex. 11 | 64 | 30000 | 2.3.E+05 | 3.0.E+03 | 0.99 | 66 | 0.975 | 6.0 |
| Ex. 12 | 65 | 32000 | 2.5.E+05 | 3.2.E+03 | 0.99 | 66 | 0.976 | 6.3 |
| Ex. 13 | 63 | 29000 | 2.6.E+05 | 5.0.E+03 | 0.96 | 55 | 0.975 | 6.1 |
| Comp. | — | 9000 | 6.0.E+04 | 1.0.E+04 | 1.10 | 0 | 0.977 | 6.1 |
| Ex. 1 | | | | | | | | |
| Comp. | 63 | 33000 | 2.2.E+04 | 2.9.E+03 | 1.02 | 66 | 0.985 | 6 |
| Ex. 2 | | | | | | | | |
| Comp. | 63 | 32000 | 2.2.E+04 | 3.0.E+03 | 0.99 | 66 | 0.989 | 6.6 |
| Ex. 3 | | | | | | | | |

In Table 1-2, “E” means “powers of 10” and for example “3.0E+03” means “3.0 × 10³.”

Table 2 collectively presents evaluation results of Examples and Comparative Examples.

TABLE 2

| | Evaluation results | | | | |
|---|---|---|---|---|---|
| | Charge- | Fixing | Heat resistance | Transfer | |
| | ability | property | storageability | rate | Cleanability |
| Ex. 1 | A | A | B | A | A |
| Ex. 2 | A | A | A | A | A |
| Ex. 3 | A | A | A | B | B |
| Ex. 4 | A | B | A | A | A |
| Ex. 5 | A | C | A | A | A |
| Ex. 6 | B | A | C | A | A |
| Ex. 7 | B | C | B | A | A |
| Ex. 8 | B | A | C | A | A |
| Ex. 9 | A | B | A | A | A |
| Ex. 10 | A | A | A | A | A |
| Ex. 11 | A | A | B | A | A |
| Ex. 12 | A | A | B | A | A |
| Ex. 13 | A | B | B | A | A |
| Comp. Ex. 1 | B | D | A | A | A |
| Comp. Ex. 2 | A | B | B | C | D |
| Comp. Ex. 3 | B | B | B | C | D |

Aspects of the present invention are, for example, as follows.

<1> A Toner Including:

a binder resin; and

a colorant,

wherein the toner is obtained by dispersing or emulsifying an oil phase in an aqueous solvent containing an organic sulfonic acid salt and an inorganic salt, the oil phase containing the binder resin and the colorant dissolved or dispersed in an organic solvent,

wherein the binder resin contains a crystalline resin in an amount of 50% by mass or more relative to the binder resin, and

wherein the toner has an average circularity of 0.980 or less.

<2> The Toner According to <1>,

wherein the organic sulfonic acid salt is an alkyl group-containing sulfonic acid salt represented by the following General Formula (1), an alkyl group-containing sulfonic acid salt represented by the following General Formula (2), or an alkyl group-containing sulfonic acid salt represented by the following General Formula (3), or any combination thereof.

CₙH₂ₙ₊₁—R¹—SO₃M General Formula (1)

CₙH₂ₙ₊₁—R¹(SO₃M)-O—R²⁻SO₃M General Formula (2)

CₙH₂ₙ₊₁—SO₃M General Formula (3)

where in General Formulas (1), (2) and (3), n is an integer of 10 to 18, R¹ is a phenyl group, R² is a phenyl group or an alkylene group, and M is a monovalent metal.

<3> The Toner According to <1> or <2>,

wherein the inorganic salt is a salt composed of a cation and an anion, where the cation is Na⁺, Mg²⁺, K⁺, Ca²⁺, or NR⁴⁺ (where R is H or a C1-C4 alkyl group) and the anion is Cl⁻, Br⁻, NO₃⁻, HCO₃⁻, CO₃²⁻, HSO₄⁻, SO₄²⁻, H₂PO₄⁻, HPO₄²⁻ or PO₄³⁻.

<4> The Toner According to any One of <1> to <3>,

wherein the oil phase further contains a layered inorganic mineral containing interlayer ions at least one of which has been modified with organic ions.

<5> The Toner According to any One of <1> to <4>,

wherein the binder resin contains a crystalline polyester resin, and the crystalline polyester resin contains, in a backbone thereof, a urethane bond, a urea bond, or both thereof.

<6> The Toner According to any One of <1> to <5>,

wherein the crystalline resin contains a first crystalline resin and a second crystalline resin, where the second crystalline resin has a weight average molecular weight Mw greater than that of the first crystalline resin.

<7> The Toner According to any One of <1> to <6>,

wherein the toner has a ratio Tsh2nd/Tshlst of 0.90 or more but 1.10 or less, where Tshlst is a shoulder temperature in a peak of heat of fusion in a first temperature raising of the toner by a differential scanning calorimeter (DSC), and Tsh2nd is a shoulder temperature in a peak of heat of fusion in a second temperature raising of the toner by the differential scanning calorimeter.

<8> The Toner According to any One of <1> to <7>,

wherein the toner has a storage modulus G′(70) (Pa) at 70° C. of more than 5.0×10⁴ Pa but less than 5.0×10⁵ Pa, and has a storage modulus G′(160) (Pa) at 160° C. of more than 1.0×10³ Pa but less than 1.0×10⁴ Pa.

<9> The Toner According to any One of <1> to <8>,

wherein a concentration of the organic sulfonic acid salt in the aqueous solvent is 0.1% by mass to 3% by mass.

<10> A Developer Including:

the toner according to any one of <1> to <9>.

<11> An Image Forming Apparatus Including:

a latent electrostatic image bearing member;

a charging unit configured to charge a surface of the latent electrostatic image bearing member;

an exposing unit configured to expose the charged surface of the latent electrostatic image bearing member to light to form a latent electrostatic image;

a developing unit configured to develop the latent electrostatic image with a toner to form a visible image;

a transfer unit configured to transfer the visible image onto a recording medium; and

a fixing unit configured to fix the visible image transferred on the recording medium,

wherein the toner is the toner according to any one of <1> to <9>.

This application claims priority to Japanese application No. 2012-074013, filed on Mar. 28, 2012, and incorporated herein by reference.

What is claimed is:

1. A toner comprising:
a binder resin; and
a colorant,
wherein the toner is obtained by dispersing or emulsifying an oil phase in an aqueous solvent containing an organic sulfonic acid salt and an inorganic salt, the oil phase comprising the binder resin and the colorant dissolved or dispersed in an organic solvent,
wherein the binder resin comprises a crystalline resin in an amount of 50% by mass or more relative to the binder resin, and
wherein the toner has an average circularity of 0.980 or less.

2. The toner according to claim 1,
wherein the organic sulfonic acid salt is an alkyl group-containing sulfonic acid salt represented by the following General Formula (1), an alkyl group-containing sulfonic acid salt represented by the following General Formula (2), or an alkyl group-containing sulfonic acid salt represented by the following General Formula (3), or any combination thereof:
CₙH₂ₙ₊₁—R¹—SO₃M General Formula (1)
CₙH₂ₙ₊₁—R¹(SO₃M)-O—R²⁻SO₃M General Formula (2)
CₙH₂ₙ₊₁—SO₃M General Formula (3)
where in General Formulas (1), (2) and (3), n is an integer of 10 to 18, R¹ is a phenyl group, R² is a phenyl group or an alkylene group, and M is a monovalent metal.

3. The toner according to claim 1,
wherein the inorganic salt is a salt composed of a cation and an anion, where the cation is Na⁺, Mg²⁺, K⁺, Ca²⁺, or NR⁴⁺ (where R is H or a C1-C4 alkyl group) and the anion is Cl⁻, Br⁻, NO₃⁻, HCO₃⁻, CO₃²⁻, HSO₄⁻, SO₄²⁺, H₂PO₄⁻, HPO₄²⁻ or PO₄³⁻.

4. The toner according to claim 1,
wherein the oil phase further comprises a layered inorganic mineral containing interlayer ions at least one of which has been modified with organic ions.

5. The toner according to claim 1,
wherein the binder resin comprises a crystalline polyester resin, and the crystalline polyester resin contains, in a backbone thereof, a urethane bond, a urea bond, or both thereof.

6. The toner according to claim 1,
wherein the crystalline resin comprises a first crystalline resin and a second crystalline resin, where the second crystalline resin has a weight average molecular weight Mw greater than that of the first crystalline resin.

7. The toner according to claim 1,
wherein the toner has a ratio Tsh2nd/Tshlst of 0.90 or more but 1.10 or less, where Tshlst is a shoulder temperature in a peak of heat of fusion in a first temperature raising of the toner by a differential scanning calorimeter (DSC), and Tsh2nd is a shoulder temperature in a peak of heat of fusion in a second temperature raising of the toner by the differential scanning calorimeter.

8. The toner according to claim 1,
wherein the toner has a storage modulus G′(70) (Pa) at 70° C. of more than 5.0×10⁴ Pa but less than 5.0×10⁵ Pa, and has a storage modulus G′(160) (Pa) at 160° C. of more than 1.0×10³ Pa but less than 1.0×10⁴ Pa.

9. The toner according to claim 1,
wherein a concentration of the organic sulfonic acid salt in the aqueous solvent is 0.1% by mass to 3% by mass.

10. A developer comprising:
a toner,
wherein the toner comprises:
a binder resin; and
a colorant;
wherein the toner is obtained by dispersing or emulsifying an oil phase in an aqueous solvent containing an organic sulfonic acid salt and an inorganic salt, the oil phase comprising the binder resin and the colorant dissolved or dispersed in an organic solvent,
wherein the binder resin comprises a crystalline resin in an amount of 50% by mass or more relative to the binder resin, and
wherein the toner has an average circularity of 0.980 or less.

11. An image forming apparatus comprising:
a latent electrostatic image bearing member;
a charging unit configured to charge a surface of the latent electrostatic image bearing member;
an exposing unit configured to expose the charged surface of the latent electrostatic image bearing member to light to form a latent electrostatic image;
a developing unit configured to develop the latent electrostatic image with a toner to form a visible image;
a transfer unit configured to transfer the visible image onto a recording medium; and
a fixing unit configured to fix the visible image transferred on the recording medium,
wherein the toner comprises:
a binder resin; and
a colorant,
wherein the toner is obtained by dispersing or emulsifying an oil phase in an aqueous solvent containing an organic sulfonic acid salt and an inorganic salt, the oil phase comprising the binder resin and the colorant dissolved or dispersed in an organic solvent,
wherein the binder resin comprises a crystalline resin in an amount of 50% by mass or more relative to the binder resin, and
wherein the toner has an average circularity of 0.980 or less.
